(19) United States
(12) Patent Application Publication
(10) Pub. No.: US 2014/0297642 A1
(43) Pub. Date: Oct. 2, 2014

(54) SYSTEMS AND METHODS FOR MAPPING PATIENT DATA FROM MOBILE DEVICES FOR TREATMENT ASSISTANCE

(71) Applicant: AYASDI, INC., Palo Alto, CA (US)

(72) Inventors: Pek Yee Lum, Palo Alto, CA (US); Damir Herman, Los Gatos, CA (US)

(73) Assignee: AYASDI, INC., Palo Alto, CA (US)

(21) Appl. No.: 14/221,141

(22) Filed: Mar. 20, 2014

Related U.S. Application Data
(63) Continuation-in-part of application No. 13/648,237, filed on Oct. 9, 2012.
Application No. 13/648,237 is a continuation-in-part of application No. 12/703,165, filed on Feb. 9, 2010.
(60) Provisional application No. 61/804,597, filed on Mar. 22, 2013.
(60) Provisional application No. 61/545,539, filed on Oct. 10, 2011.
(60) Provisional application No. 61/151,488, filed on Feb. 10, 2009.

(51) Int. Cl. G06F 19/00

(52) U.S. Cl. CPC G06F 19/36
USPC 707/737

(57) ABSTRACT

In various embodiments, a system comprises a map and a patient data assessment module. The map includes a plurality of groupings and interconnections of the groupings, each grouping having one or more patient members that share biological similarities, each interconnection interconnecting groupings that share at least one common patient member, the map identifying a set of groupings and a set of interconnections having a medical characteristic of a set of medical characteristics. The patient data assessment module may be configured to receive sensor data from a user's mobile device and to assess the sensor data to generate user medical attributes, to determine whether the user shares the biological similarities with the one or more patient members of each grouping based, at least in part, on the user medical attributes, thereby enabling association of the user with one or more of the set of medical characteristics.

### CROSS REFERENCE TO RELATED APPLICATIONS

This application claims priority to U.S. Provisional Patent Application Ser. No. 61/804,597, filed Mar. 22, 2013 and entitled “Predicting Parkinson's Disease with Smartphone Data,” which is incorporated by reference herein. This application is also a continuation-in-part of U.S. Nonprovisional patent application Ser. No. 13/648,237, filed Oct. 9, 2012 and entitled “Systems and Methods for Mapping New Patient Information to Historic Outcomes for Treatment Assistance,” which claims priority to U.S. Provisional Patent Application Ser. No. 61/545,539, filed Oct. 10, 2011 and entitled “Systems and Methods for Application of a Predictive and Visual Cancer Map,” both of which are incorporated by reference herein. Further, U.S. Nonprovisional patent application Ser. No. 13/648,237 is a continuation-in-part of U.S. Nonprovisional patent application Ser. No. 12/703,165, filed Feb. 9, 2010 and entitled “Systems and Methods for Visualization of Data Analysis,” which claims priority to U.S. Provisional Patent Application Ser. No. 61/151,488, filed Feb. 10, 2009 and entitled “Mapper: an Environment for Visual Data Analysis,” all of which are incorporated by reference herein.

### BACKGROUND

1. Field of the Invention

Embodiments of the present invention are directed to collecting new patient data over mobile devices and more particularly to mapping collected new patient data from mobile devices for treatment assistance.

2. Related Art

As the collection and storage data has increased, there is an increased need to analyze and make sense of large amounts of data. Examples of large datasets may be found in financial services companies, oil expiration, biotech, and academia. Unfortunately, previous methods of analysis of large multidimensional datasets tend to be insufficient (if possible at all) to identify important relationships and may be computationally inefficient.

In one example, previous methods of analysis often use clustering. Clustering is often too blunt an instrument to identify important relationships in the data. Similarly, previous methods of linear regression, projection pursuit, principal component analysis, and multidimensional scaling often do not reveal important relationships. Existing linear algebraic and analytic methods are too sensitive to large scale distances and, as a result, lose detail.

Further, even if the data is analyzed, sophisticated experts are often necessary to interpret and understand the output of previous methods. Although some previous methods allow graphs depicting some relationships in the data, the graphs are not interactive and require considerable time for a team of such experts to understand the relationships. Further, the output of previous methods does not allow for exploratory data analysis where the analysis can be quickly modified to discover new relationships. Rather, previous methods require the formulation of a hypothesis before testing.

Etiologies of many diseases have a genetic basis. For example, many types of cancer arise when genes regulating cell growth and differentiation mutate, and the mutations are propagated during subsequent cell divisions, thereby causing uncontrolled cell growth and proliferation. Thus, techniques that measure the relative “activity” of genes (e.g., levels of gene transcripts), called gene expression profiling techniques, can be used to assess which genes are involved in the etiology of a given type of cancer, or more generally, a disease that is caused by a genetic mutation or aberration.

Gene expression profiling techniques estimate the activity of thousands of different genes simultaneously. Gene expression techniques typically measure the level of messenger RNA (mRNA)—molecules that are intermediaries between the genes encoded by DNA and proteins, the primary structural and functional components of cells—as a proxy for the activity of genes in cells under various conditions. Some gene expression profiling techniques, such as DNA microarray technologies, measure the relative activity of known target genes. Other gene expression techniques based on high-throughput sequencing technologies can measure the relative activity of any gene, including previously unidentified genes.

Gene expression profiling techniques are currently used in the identification of specific types of cancer. Various cancer subtypes have been defined by the gene expression patterns, or molecular signatures, observed in various tumors. The cancer subtypes include the tissue or cell type giving rise to the tumor, and specific subtypes of cancer that arise from the same tissue or cell types. A patient's cancer subtype can thus be diagnosed when a doctor takes a biopsy of the patient's tumor and submits it for analysis using a gene expression profiling technique.

Such diagnoses currently have limited therapeutic utility. It is not uncommon that the results of the diagnosis consists of a single value that may indicate a likelihood of a specific cancer. Merely identifying a cancer or tumor subtype, however, does not necessarily provide guidance to the physician on the expected outcome of a patient with a certain cancer subtype, nor the appropriate treatment for a patient with a particular cancer subtype. Currently, a patient's prognosis and therapeutic options are typically determined by a doctor, using his or her experience alone, based on the diagnosis.

### SUMMARY

In various embodiments, a system comprises a map and a patient data assessment module. The map includes a plurality of groupings and interconnections of the groupings, each grouping having one or more patient members that share biological similarities, each interconnection interconnecting groupings that share at least one common patient member, the map identifying a set of groupings and a set of interconnections having a medical characteristic of a set of medical characteristics. The patient data assessment module may be configured to receive sensor data from a user's mobile device and to assess the sensor data to generate user medical attributes, to determine whether the user shares the biological similarities with the one or more patient members of each grouping based, at least in part, on the user medical attributes, thereby enabling association of the user with one or more of the set of medical characteristics.

In various embodiments, the biological similarities represent similarities of measurements of sensor data of mobile devices associated with the one or more patient members. The sensor data may comprise accelerometer sensor data. In some embodiments, the map is generated by an analysis system configured to receive sensor data associated with the one or more patient members, apply a filtering function to generate a reference space, generate a cover of the reference space based on a resolution, the cover including cover data associated with the filtered sensor data, and cluster the cover data based on a metric. The filtering function may be a density estimation function. The metric may be a Pearson correlation.

The patient data assessment module maybe configured to determine whether the user shares the biological similarities with the one or more patient members of each grouping comprises the patient data assessment module configured to determine a distance between biological data of a subset of patient members and sensor data of the user, compare distances between a representative patient member of the subset of patient members and the distances determined for the user, and determine a location of the user relative to at least one of the patient members. In some embodiments, the map is not displayed.

The system may further comprise a trigger module configured to retrieve a trigger profile based on a condition classification, to determine if the user medical attributes satisfies trigger conditions of a trigger associated with the trigger profile, and to provide an alert based on the determination. The medical characteristic may comprise a clinical outcome.

An exemplary method may comprise receiving sensor data from a user's mobile device, assessing the sensor data to generate user medical attributes of a user, determining distances between biological data of patient members of map and medical attributes from the user, the map including a plurality of groupings and interconnections of the groupings, each grouping having one or more of the patient members that share biological similarities, each interconnection interconnecting groupings that share at least one common patient member, the map identifying a set of groupings and a set of interconnections having a medical characteristic of a set of medical characteristics, comparing distances between the one or more patient members and the distances determined for the user, and determining a location of the user relative to the member patients of the map based on the comparison, thereby enabling association of the new patient with one or more of the set of medical characteristics.

An exemplary non-transitory computer readable medium may comprise instructions. The instructions may be executable by a processor to perform a method. The may comprise receiving sensor data from a user's mobile device, assessing the sensor data to generate user medical attributes of a user, determining distances between biological data of patient members of map and medical attributes from the user, the map including a plurality of groupings and interconnections of the groupings, each grouping having one or more of the patient members that share biological similarities, each interconnection interconnecting groupings that share at least one common patient member, the map identifying a set of groupings and a set of interconnections having a medical characteristic of a set of medical characteristics, comparing distances between the one or more patient members and the distances determined for the user, and determining a location of the user relative to the member patients of the map based on the comparison, thereby enabling association of the new patient with one or more of the set of medical characteristics.

### BRIEF DESCRIPTION OF THE DRAWINGS

FIG. 1 is an exemplary environment in which embodiments may be practiced.

FIG. 2 is a block diagram of an exemplary analysis server.

FIG. 3 is a flow chart depicting an exemplary method of dataset analysis and visualization in some embodiments.

FIG. 4 is an exemplary ID field selection interface window in some embodiments.

FIG. 5 is an exemplary data field selection interface window in some embodiments.

FIG. 6 is an exemplary metric and filter selection interface window in some embodiments.

FIG. 7 is an exemplary filter parameter interface window in some embodiments.

FIG. 8 is a flowchart for data analysis and generating a visualization in some embodiments.

FIG. 9 is an exemplary interactive visualization in some embodiments.

FIG. 10 is an exemplary interactive visualization displaying an explain information window in some embodiments.

FIG. 11 is a flowchart of functionality of the interactive visualization in some embodiments.

FIG. 12 is a flowchart of for generating a cancer map visualization utilizing biological data of a plurality of patients in some embodiments.

FIG. 13 is an exemplary data structure including biological data for a number of patients that may be used to generate the cancer map visualization in some embodiments.

FIG. 14 is an exemplary visualization displaying the cancer map in some embodiments.

FIG. 15 is a flowchart of for positioning new patient data relative to the cancer map visualization in some embodiments.

FIG. 16 is an exemplary visualization displaying the cancer map including positions for three new cancer patients in some embodiments.

FIG. 17 is a flowchart of utilization the visualization and positioning of new patient data in some embodiments

FIG. 18 is an exemplary digital device in some embodiments.

FIG. 19 depicts an environment in which embodiments may be practiced.

FIG. 20 is a block diagram of the mobile device in some embodiments.

FIG. 21 is a flowchart for collecting sensor data by the mobile device in some embodiments.

FIG. 22 is a block diagram of an analysis device in some embodiments.

FIG. 23 is an exemplary data structure including sensor data for a number of patients that may be used to generate the map in some embodiments.

FIG. 24 is a flowchart of for positioning new patient sensor data relative to a medical characteristic map in some embodiments.

FIG. 25 is a flowchart for providing alerts based on satisfaction of a trigger condition based at least in part on sensor data of the user in some embodiments.

FIG. 26 depicts a visualization of the medical condition map in some embodiments.

FIG. 27 depicts a new patient location on a visualization of the medical condition map before treatment in some embodiments.

FIG. 28 depicts a new patient location on a visualization of the medical condition map after treatment in some embodiments.

FIG. 29 depicts a new patient's change in location on a visualization of the medical condition map after treatment in some embodiments.

FIG. 30 is a display of a map depicting audio data at 60 second window of length 12 second intervals with 4 second hops (e.g., 12 second intervals that being every multiple of four seconds from the beginning of the time sequences).

FIG. 31 depicts a table that describes the groups in some embodiments.

FIG. 32 depicts a comparison between the original acceleration time series data over a 3 hr interval for an exemplary subject in some embodiments.

### DETAILED DESCRIPTION OF EXEMPLARY EMBODIMENTS

In various embodiments, a system for handling, analyzing, and visualizing data using drag and drop methods as opposed to text based methods is described herein. Philosophically, data analytic tools are not necessarily regarded as “solvers,” but rather as tools for interacting with data. For example, data analysis may consist of several iterations of a process in which computational tools point to regions of interest in a data set. The data set may then be examined by people with domain expertise concerning the data, and the data set may then be subjected to further computational analysis. In some embodiments, methods described herein provide for going back and forth between mathematical constructs, including interactive visualizations (e.g., graphs), on the one hand and data on the other.

In one example of data analysis in some embodiments described herein, an exemplary clustering tool is discussed which may be more powerful than existing technology, in that one can find structure within clusters and study how clusters change over a period of time or over a change of scale or resolution.

An exemplary interactive visualization tool (e.g., a visualization module which is further described herein) may produce combinatorial output in the form of a graph which can be readily visualized. In some embodiments, the exemplary interactive visualization tool may be less sensitive to changes in notions of distance than current methods, such as multidimensional scaling.

Some embodiments described herein permit manipulation of the data from a visualization. For example, portions of the data which are deemed to be interesting from the visualization can be selected and converted into database objects, which can then be further analyzed. Some embodiments described herein permit the location of data points of interest within the visualization, so that the connection between a given visualization and the information the visualization represents may be readily understood.

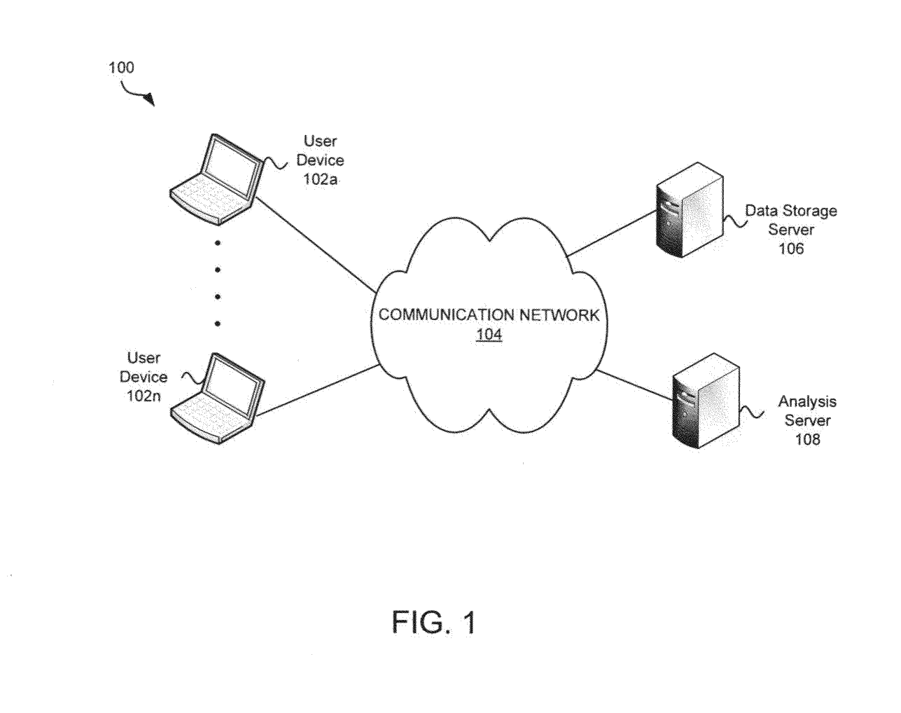

FIG. 1 is an exemplary environment 100 in which embodiments may be practiced. In various embodiments, data analysis and interactive visualization may be performed locally (e.g., with software and/or hardware on a local digital device), across a network (e.g., via cloud computing), or a combination of both. In many of these embodiments, a data structure is accessed to obtain the data for the analysis, the analysis is performed based on properties and parameters selected by a user, and an interactive visualization is generated and displayed. There are many advantages between performing all or some activities locally and many advantages of performing all or some activities over a network.

Environment 100 comprises user devices 102a-102n, a communication network 104, data storage server 106, and analysis server 108. Environment 100 depicts an embodiment wherein functions are performed across a network. In this example, the user(s) may take advantage of cloud computing by storing data in a data storage server 106 over a communication network 104. The analysis server 108 may perform analysis and generation of an interactive visualization.

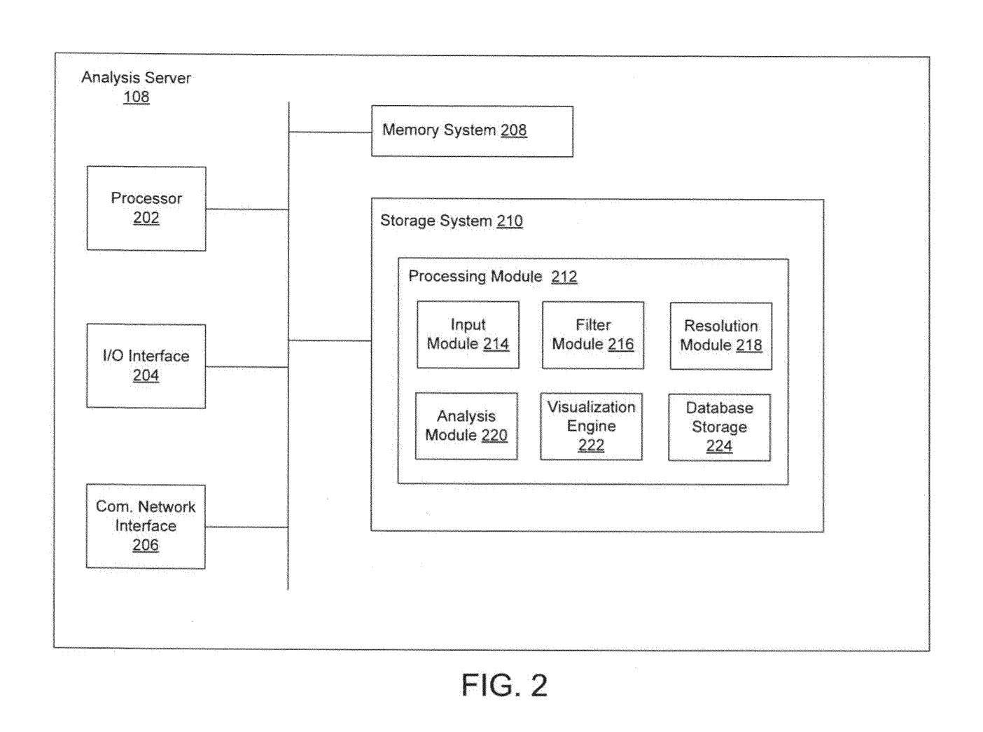

User devices 102a-102n may be any digital devices. A digital device is any device that comprises memory and a processor. Digital devices are further described in FIG. 2. The user devices 102a-102n may be any kind of digital device that may be used to access, analyze and/or view data including, but not limited to a desktop computer, laptop, notebook, or other computing device.

In various embodiments, a user, such as a data analyst, may generate a database or other data structure with the user device 102a to be saved to the data storage server 106. The user device 102a may communicate with the analysis server 108 via the communication network 104 to perform analysis, examination, and visualization of data within the database.

The user device 102a may comprise a client program for interacting with one or more applications on the analysis server 108. In other embodiments, the user device 102a may communicate with the analysis server 108 using a browser or other standard program. In various embodiments, the user device 102a communicates with the analysis server 108 via a virtual private network. Those skilled in the art will appreciate that that communication between the user device 102a, the data storage server 106, and/or the analysis server 108 may be encrypted or otherwise secured.

The communication network 104 may be any network that allows digital devices to communicate. The communication network 104 may be the Internet and/or include LAN and WANs. The communication network 104 may support wireless and/or wired communication.

The data storage server 110 is a digital device that is configured to store data. In various embodiments, the data storage server 110 stores databases and/or other data structures. The data storage server 110 may be a single server or a combination of servers. In one example the data storage server 110 may be a secure server wherein a user may store data over a secured connection (e.g., via https). The data may be encrypted and backed-up. In some embodiments, the data storage server 106 is operated by a third-party such as Amazon's S3 service.

The database or other data structure may comprise large high-dimensional datasets. These datasets are traditionally very difficult to analyze and, as a result, relationships within the data may not be identifiable using previous methods. Further, previous methods may be computationally inefficient.

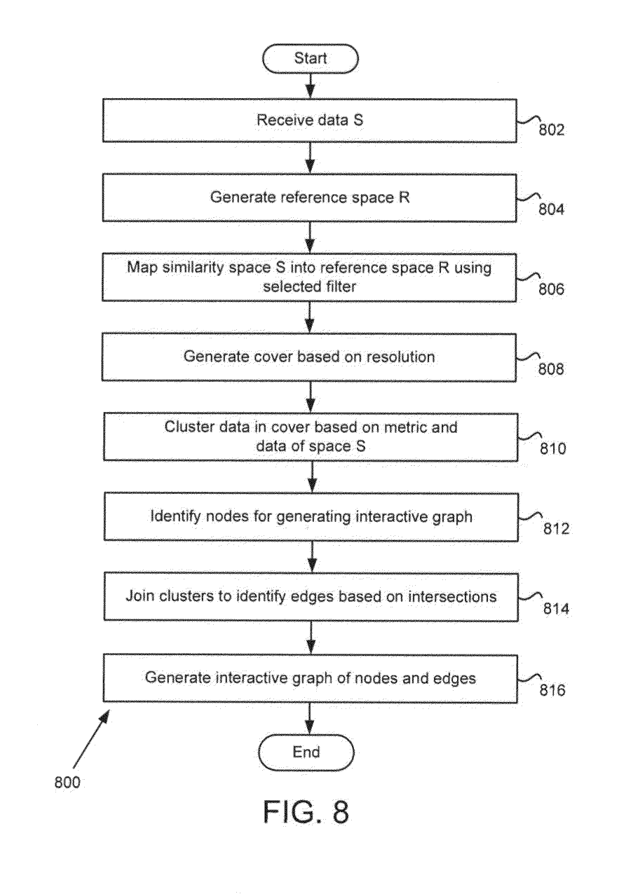

The analysis server 108 is a digital device that may be configured to analyze data. In various embodiments, the analysis server may perform many functions to interpret, examine, analyze, and display data and/or relationships within data. In some embodiments, the analysis server 108 performs, at least in part, topological analysis of large datasets applying metrics, filters, and resolution parameters chosen by the user. The analysis is further discussed in FIG. 8 herein.

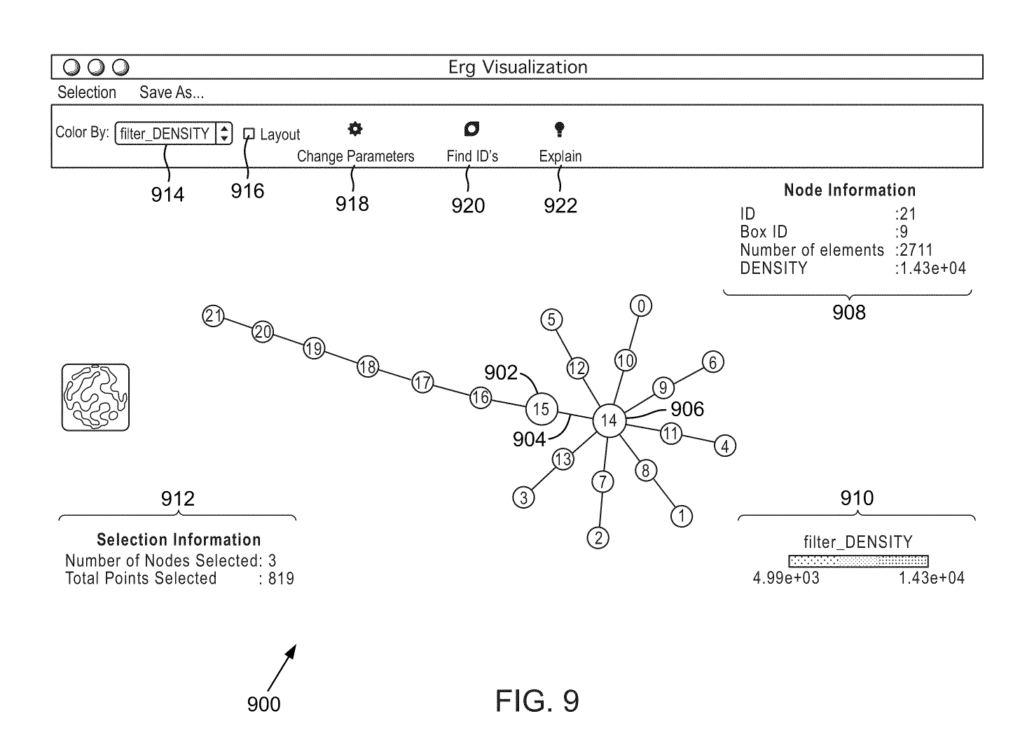

The analysis server 108 may generate an interactive visualization of the output of the analysis. The interactive visualization allows the user to observe and explore relationships in the data. In various embodiments, the interactive visualization allows the user to select nodes comprising data that has been clustered. The user may then access the underlying data, perform further analysis (e.g., statistical analysis) on the underlying data, and manually reorient the graph(s) (e.g., structures of nodes and edges described herein) within the interactive visualization. The analysis server 108 may also allow for the user to interact with the data, see the graphic result. The interactive visualization is further discussed in FIGS. 9-11.

In some embodiments, the analysis server 108 interacts with the user device(s) 102a-102n over a private and/or secure communication network. The user device 102a may comprise a client program that allows the user to interact with the data storage server 106, the analysis server 108, another user device (e.g., user device 102n), a database, and/or an analysis application executed on the analysis server 108.

Those skilled in the art will appreciate that all or part of the data analysis may occur at the user device 102a. Further, all or part of the interaction with the visualization (e.g., graphic) may be performed on the user device 102a.

Although two user devices 102a and 102n are depicted, those skilled in the art will appreciate that there may be any number of user devices in any location (e.g., remote from each other). Similarly, there may be any number of communication networks, data storage servers, and analysis servers.

Cloud computing may allow for greater access to large datasets (e.g., via a commercial storage service) over a faster connection. Further, those skilled in the art will appreciate that services and computing resources offered to the user(s) may be scalable.

FIG. 2 is a block diagram of an exemplary analysis server 108. In exemplary embodiments, the analysis server 108 comprises a processor 202, input/output (I/O) interface 204, a communication network interface 206, a memory system 208, and a storage system 210. The processor 202 may comprise any processor or combination of processors with one or more cores.

The input/output (I/O) device 204 may comprise interfaces for various I/O devices such as, for example, a keyboard, mouse, and display device. The exemplary communication network interface 206 is configured to allow the analysis server 108 to communication with the communication network 104 (see FIG. 1). The communication network interface 206 may support communication over an Ethernet connection, a serial connection, a parallel connection, and/or an ATA connection. The communication network interface 206 may also support wireless communication (e.g., 802.11a/b/g/n, WiMax, LTE, WiFi). It will be apparent to those skilled in the art that the communication network interface 206 can support many wired and wireless standards.

The memory system 208 may be any kind of memory including RAM, ROM, or flash, cache, virtual memory, etc. In various embodiments, working data is stored within the memory system 208. The data within the memory system 208 may be cleared or ultimately transferred to the storage system 210.

The storage system 210 includes any storage configured to retrieve and store data. Some examples of the storage system 210 include flash drives, hard drives, optical drives, and/or magnetic tape. Each of the memory system 208 and the storage system 210 comprises a computer-readable medium, which stores instructions (e.g., software programs) executable by processor 202.

The storage system 210 comprises a plurality of modules utilized by embodiments of the present invention. A module may be hardware, software (e.g., including instructions executable by a processor), or a combination of both. In one embodiment, the storage system 210 comprises a processing module 212 which comprises an input module 214, a filter module 216, a resolution module 218, an analysis module 220, a visualization engine 222, and database storage 224. Alternative embodiments of the analysis server 108 and/or the storage system 210 may comprise more, less, or functionally equivalent components and modules.

The input module 214 may be configured to receive commands and preferences from the user device 102a. In various examples, the input module 214 receives selections from the user which will be used to perform the analysis. The output of the analysis may be an interactive visualization.

The input module 214 may provide the user a variety of interface windows allowing the user to select and access a database, choose fields associated with the database, choose a metric, choose one or more filters, and identify resolution parameters for the analysis. In one example, the input module 214 receives a database identifier and accesses a large multi-dimensional database. The input module 214 may scan the database and provide the user with an interface window allowing the user to identify an ID field. An ID field is an identifier for each data point. In one example, the identifier is unique. The same column name may be present in the table from which filters are selected. After the ID field is selected, the input module 214 may then provide the user with another interface window to allow the user to choose one or more data fields from a table of the database.

Although interactive windows may be described herein, those skilled in the art will appreciate that any window, graphical user interface, and/or command line may be used to receive or prompt a user or user device 102a for information.

The filter module 216 may subsequently provide the user with an interface window to allow the user to select a metric to be used in analysis of the data within the chosen data fields. The filter module 216 may also allow the user to select and/or define one or more filters.

The resolution module 218 may allow the user to select a resolution, including filter parameters. In one example, the user enters a number of intervals and a percentage overlap for a filter.

The analysis module 220 may perform data analysis based on the database and the information provided by the user. In various embodiments, the analysis module 220 performs an algebraic topological analysis to identify structures and relationships within data and clusters of data. Those skilled in the art will appreciate that the analysis module 220 may use parallel algorithms or use generalizations of various statistical techniques (e.g., generalizing the bootstrap to zig-zag methods) to increase the size of data sets that can be processed. The analysis is further discussed in FIG. 8. Those skilled in the art will appreciate that the analysis module 220 is not limited to algebraic topological analysis but may perform any analysis.

The visualization engine 222 generates an interactive visualization including the output from the analysis module 220. The interactive visualization allows the user to see all or part of the analysis graphically. The interactive visualization also allows the user to interact with the visualization. For example, the user may select portions of a graph from within the visualization to see and/or interact with the underlying data and/or underlying analysis. The user may then change the parameters of the analysis (e.g., change the metric, filter(s), or resolution(s)) which allows the user to visually identify relationships in the data that may be otherwise undetectable using prior means. The interactive visualization is further described in FIGS. 9-11.

The database storage 224 is configured to store all or part of the database that is being accessed. In some embodiments, the database storage 224 may store saved portions of the database. Further, the database storage 224 may be used to store user preferences, parameters, and analysis output thereby allowing the user to perform many different functions on the database without losing previous work.

Those skilled in the art will appreciate that that all or part of the processing module 212 may be at the user device 102a or the database storage server 106. In some embodiments, all or some of the functionality of the processing module 212 may be performed by the user device 102a.

In various embodiments, systems and methods discussed herein may be implemented with one or more digital devices. In some examples, some embodiments discussed herein may be implemented by a computer program (instructions) executed by a processor. The computer program may provide a graphical user interface. Although such a computer program is discussed, those skilled in the art will appreciate that embodiments may be performed using any of the following, either alone or in combination, including, but not limited to, a computer program, multiple computer programs, firmware, and/or hardware.

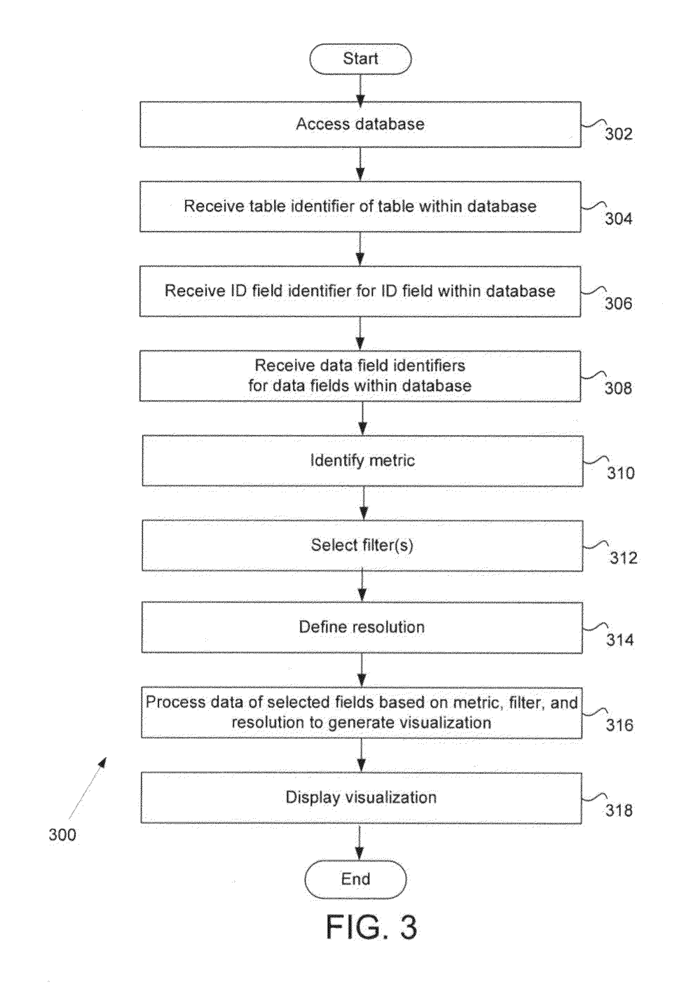

FIG. 3 is a flow chart 300 depicting an exemplary method of dataset analysis and visualization in some embodiments. In step 302, the input module 214 accesses a database. The database may be any data structure containing data (e.g., a very large dataset of multidimensional data). In some embodiments, the database may be a relational database. In some examples, the relational database may be used with MySQL, Oracle, Micosoft SQL Server, Aster nCluster, Teradata, and/or Vertica. Those skilled in the art will appreciate that the database may not be a relational database.

In some embodiments, the input module 214 receives a database identifier and a location of the database (e.g., the data storage server 106) from the user device 102a (see FIG. 1). The input module 214 may then access the identified database. In various embodiments, the input module 214 may read data from many different sources, including, but not limited to MS Excel files, text files (e.g., delimited or CSV), Matlab .mat format, or any other file.

In some embodiments, the input module 214 receives an IP address or hostname of a server hosting the database, a username, password, and the database identifier. This information (herein referred to as “connection information”) may be cached for later use. Those skilled in the art will appreciate that the database may be locally accessed and that all, some, or none of the connection information may be required. In one example, the user device 102a may have full access to the database stored locally on the user device 102a so the IP address is unnecessary. In another example, the user device 102a may already have loaded the database and the input module 214 merely begins by accessing the loaded database.

In various embodiments, the identified database stores data within tables. A table may have a “column specification” which stores the names of the columns and their data types. A “row” in a table, may be a tuple with one entry for each column of the correct type. In one example, a table to store employee records might have a column specification such as:
employee_id primary key int (this may store the employee's ID as an integer, and uniquely identifies a row)
age int
gender char(1) (gender of the employee may be a single character either M or F)
salary double (salary of an employee may be a floating point number)
name varchar (name of the employee may be a variable-length string)
   In this example, each employee corresponds to a row in this table. Further, the tables in this exemplary relational database are organized into logical units called databases. An analogy to file systems is that databases can be thought of as folders and files as tables. Access to databases may be controlled by the database administrator by assigning a username/password pair to authenticate users.

Once the database is accessed, the input module 214 may allow the user to access a previously stored analysis or to begin a new analysis. If the user begins a new analysis, the input module 214 may provide the user device 102a with an interface window allowing the user to identify a table from within the database. In one example, the input module 214 provides a list of available tables from the identified database.

In step 304, the input module 214 receives a table identifier identifying a table from within the database. The input module 214 may then provide the user with a list of available ID fields from the table identifier. In step 306, the input module 214 receives the ID field identifier from the user and/or user device 102a. The ID field is, in some embodiments, the primary key.

Having selected the primary key, the input module 214 may generate a new interface window to allow the user to select data fields for analysis. In step 308, the input module 214 receives data field identifiers from the user device 102a. The data within the data fields may be later analyzed by the analysis module 220.

In step 310, the filter module 216 identifies a metric. In some embodiments, the filter module 216 and/or the input module 214 generates an interface window allowing the user of the user device 102a options for a variety of different metrics and filter preferences. The interface window may be a drop down menu identifying a variety of distance metrics to be used in the analysis. Metric options may include, but are not limited to, Euclidean, DB Metric, variance normalized Euclidean, and total normalized Euclidean. The metric and the analysis are further described herein.

In step 312, the filter module 216 selects one or more filters. In some embodiments, the user selects and provides filter identifier(s) to the filter module 216. The role of the filters in the analysis is also further described herein. The filters, for example, may be user defined, geometric, or based on data which has been pre-processed. In some embodiments, the data based filters are numerical arrays which can assign a set of real numbers to each row in the table or each point in the data generally.

A variety of geometric filters may be available for the user to choose. Geometric filters may include, but are not limited to:
Density
L1 Eccentricity
L-infinity Eccentricity
Witness based Density
Witness based Eccentricity
Eccentricity as distance from a fixed point
Approximate Kurtosis of the Eccentricity

In step 314, the resolution module 218 defines the resolution to be used with a filter in the analysis. The resolution may comprise a number of intervals and an overlap parameter. In various embodiments, the resolution module 218 allows the user to adjust the number of intervals and overlap parameter (e.g., percentage overlap) for one or more filters.

In step 316, the analysis module 220 processes data of selected fields based on the metric, filter(s), and resolution(s) to generate the visualization. This process is discussed in FIG. 8.

In step 318, the visualization module 222 displays the interactive visualization. In various embodiments, the visualization may be rendered in two or three dimensional space. The visualization module 222 may use an optimization algorithm for an objective function which is correlated with good visualization (e.g., the energy of the embedding). The visualization may show a collection of nodes corresponding to each of the partial clusters in the analysis output and edges connecting them as specified by the output. The interactive visualization is further discussed in FIGS. 9-11.

Although many examples discuss the input module 214 as providing interface windows, those skilled in the art will appreciate that all or some of the interface may be provided by a client on the user device 102a. Further, in some embodiments, the user device 102a may be running all or some of the processing module 212.

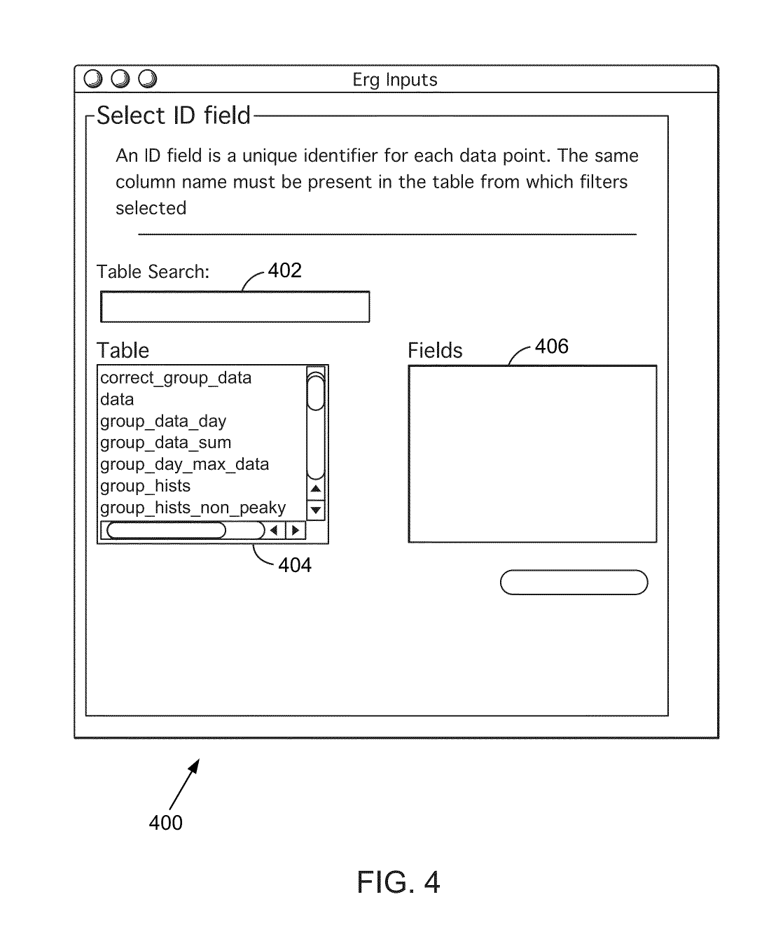

FIGS. 4-7 depict various interface windows to allow the user to make selections, enter information (e.g., fields, metrics, and filters), provide parameters (e.g., resolution), and provide data (e.g., identify the database) to be used with analysis. Those skilled in the art will appreciate that any graphical user interface or command line may be used to make selections, enter information, provide parameters, and provide data.

FIG. 4 is an exemplary ID field selection interface window 400 in some embodiments. The ID field selection interface window 400 allows the user to identify an ID field. The ID field selection interface window 400 comprises a table search field 402, a table list 404, and a fields selection window 406.

In various embodiments, the input module 214 identifies and accesses a database from the database storage 224, user device 102a, or the data storage server 106. The input module 214 may then generate the ID field selection interface window 400 and provide a list of available tables of the selected database in the table list 404. The user may click on a table or search for a table by entering a search query (e.g., a keyword) in the table search field 402. Once a table is identified (e.g., clicked on by the user), the fields selection window 406 may provide a list of available fields in the selected table. The user may then choose a field from the fields selection window 406 to be the ID field. In some embodiments, any number of fields may be chosen to be the ID field(s).

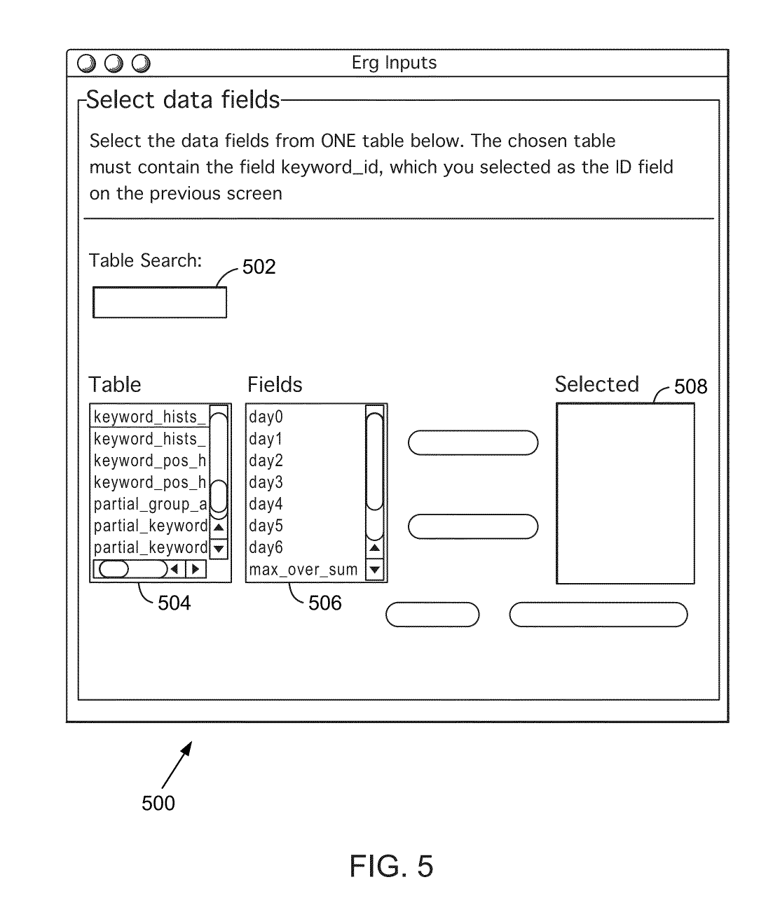

FIG. 5 is an exemplary data field selection interface window 500 in some embodiments. The data field selection interface window 500 allows the user to identify data fields. The data field selection interface window 500 comprises a table search field 502, a table list 504, a fields selection window 506, and a selected window 508.

In various embodiments, after selection of the ID field, the input module 214 provides a list of available tables of the selected database in the table list 504. Similar to the table search field 402 in FIG. 4, the user may click on a table or search for a table by entering a search query (e.g., a keyword) in the table search field 502. Once a table is identified (e.g., clicked on by the user), the fields selection window 506 may provide a list of available fields in the selected table. The user may then choose any number of fields from the fields selection window 506 to be data fields. The selected data fields may appear in the selected window 508. The user may also deselect fields that appear in the selected window 508.

Those skilled in the art will appreciate that the table selected by the user in the table list 504 may be the same table selected with regard to FIG. 4. In some embodiments, however, the user may select a different table. Further, the user may, in various embodiments, select fields from a variety of different tables.

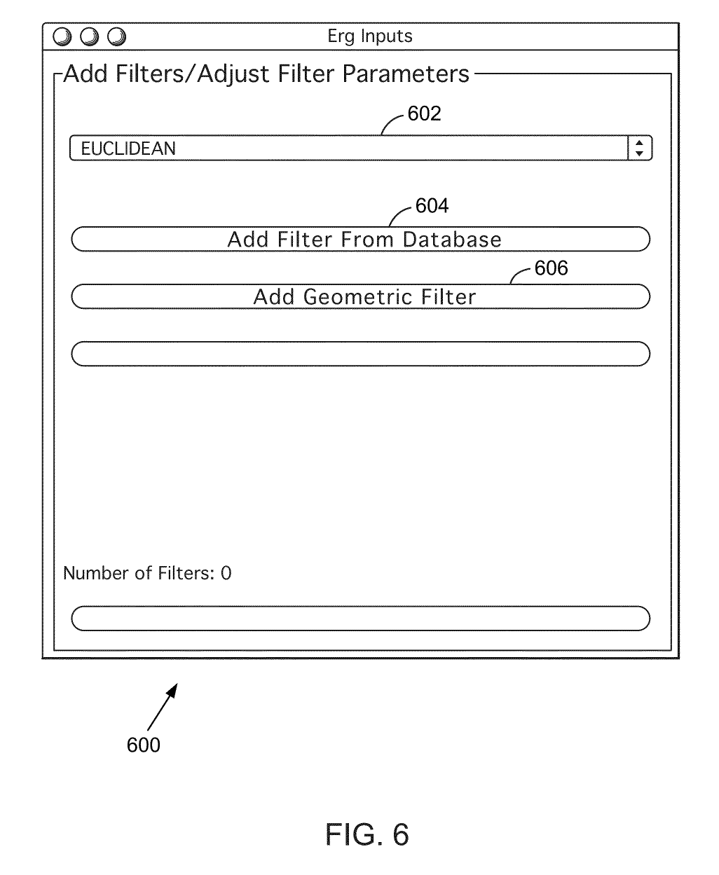

FIG. 6 is an exemplary metric and filter selection interface window 600 in some embodiments. The metric and filter selection interface window 600 allows the user to identify a metric, add filter(s), and adjust filter parameters. The metric and filter selection interface window 600 comprises a metric pull down menu 602, an add filter from database button 604, and an add geometric filter button 606.

In various embodiments, the user may click on the metric pull down menu 602 to view a variety of metric options. Various metric options are described herein. In some embodiments, the user may define a metric. The user defined metric may then be used with the analysis.

In one example, finite metric space data may be constructed from a data repository (i.e., database, spreadsheet, or Matlab file). This may mean selecting a collection of fields whose entries will specify the metric using the standard Euclidean metric for these fields, when they are floating point or integer variables. Other notions of distance, such as graph distance between collections of points, may be supported.

The analysis module 220 may perform analysis using the metric as a part of a distance function. The distance function can be expressed by a formula, a distance matrix, or other routine which computes it. The user may add a filter from a database by clicking on the add filter from database button 604. The metric space may arise from a relational database, a Matlab file, an Excel spreadsheet, or other methods for storing and manipulating data. The metric and filter selection interface window 600 may allow the user to browse for other filters to use in the analysis. The analysis and metric function are further described in FIG. 8.

The user may also add a geometric filter 606 by clicking on the add geometric filter button 606. In various embodiments, the metric and filter selection interface window 600 may provide a list of geometric filters from which the user may choose.

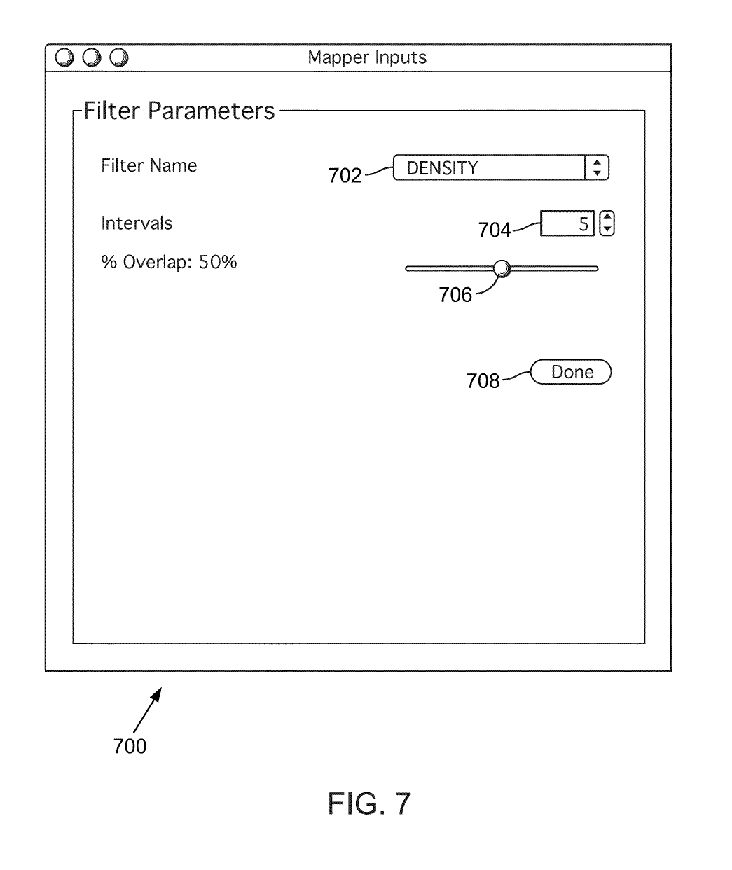

FIG. 7 is an exemplary filter parameter interface window 700 in some embodiments. The filter parameter interface window 700 allows the user to determine a resolution for one or more selected filters (e.g., filters selected in the metric and filter selection interface window 600). The filter parameter interface window 700 comprises a filter name menu 702, an interval field 704, an overlap bar 706, and a done button 708.

The filter parameter interface window 700 allows the user to select a filter from the filter name menu 702. In some embodiments, the filter name menu 702 is a drop down box indicating all filters selected by the user in the metric and filter selection interface window 600. Once a filter is chosen, the name of the filter may appear in the filter name menu 702. The user may then change the intervals and overlap for one, some, or all selected filters.

The interval field 704 allows the user to define a number of intervals for the filter identified in the filter name menu 702. The user may enter a number of intervals or scroll up or down to get to a desired number of intervals. Any number of intervals may be selected by the user. The function of the intervals is further discussed in FIG. 8.

The overlap bar 706 allows the user to define the degree of overlap of the intervals for the filter identified in the filter name menu 702. In one example, the overlap bar 706 includes a slider that allows the user to define the percentage overlap for the interval to be used with the identified filter. Any percentage overlap may be set by the user.

Once the intervals and overlap are defined for the desired filters, the user may click the done button. The user may then go back to the metric and filter selection interface window 600 and see a new option to run the analysis. In some embodiments, the option to run the analysis may be available in the filter parameter interface window 700. Once the analysis is complete, the result may appear in an interactive visualization which is further described in FIGS. 9-11.

Those skilled in the art will appreciate that that interface windows in FIGS. 4-7 are exemplary. The exemplary interface windows are not limited to the functional objects (e.g., buttons, pull down menus, scroll fields, and search fields) shown. Any number of different functional objects may be used. Further, as described herein, any other interface, command line, or graphical user interface may be used.

FIG. 8 is a flowchart 800 for data analysis and generating an interactive visualization in some embodiments. In various embodiments, the processing on data and user-specified options is motivated by techniques from topology and, in some embodiments, algebraic topology. These techniques may be robust and general. In one example, these techniques apply to almost any kind of data for which some qualitative idea of “closeness” or “similarity” exists. The techniques discussed herein may be robust because the results may be relatively insensitive to noise in the data, user options, and even to errors in the specific details of the qualitative measure of similarity, which, in some embodiments, may be generally refer to as “the distance function” or “metric.” Those skilled in the art will appreciate that while the description of the algorithms below may seem general, the implementation of techniques described herein may apply to any level of generality.

In step 802, the input module 214 receives data S. In one example, a user identifies a data structure and then identifies ID and data fields. Data S may be based on the information within the ID and data fields. In various embodiments, data S is treated as being processed as a finite “similarity space,” where data S has a real-valued function d defined on pairs of points s and t in S, such that:

d(s,s)=0

d(s,t)=d(t,s)

d(s,t)>=0

These conditions may be similar to requirements for a finite metric space, but the conditions may be weaker. In various examples, the function is a metric.

Those skilled in the art will appreciate that data S may be a finite metric space, or a generalization thereof, such as a graph or weighted graph. In some embodiments, data S be specified by a formula, an algorithm, or by a distance matrix which specifies explicitly every pairwise distance.

In step 804, the input module 214 generates reference space R. In one example, reference space R may be a well-known metric space (e.g., such as the real line). The reference space R may be defined by the user. In step 806, the analysis module 220 generates a map ref( ) from S into R. The map ref( ) from S into R may be called the “reference map.”

In one example, a reference of map from S is to a reference metric space R. R may be Euclidean space of some dimension, but it may also be the circle, torus, a tree, or other metric space. The map can be described by one or more filters (i.e., real valued functions on S). These filters can be defined by geometric invariants, such as the output of a density estimator, a notion of data depth, or functions specified by the origin of S as arising from a data set.

In step 808, the resolution module 218 generates a cover of R based on the resolution received from the user (e.g., filter(s), intervals, and overlap—see FIG. 7). The cover of R may be a finite collection of open sets (in the metric of R) such that every point in R lies in at least one of these sets. In various examples, R is k-dimensional Euclidean space, where k is the number of filter functions. More precisely in this example, R is a box in k-dimensional Euclidean space given by the product of the intervals [min_k, max_k], where min_k is the minimum value of the k-th filter function on S, and max_k is the maximum value.

For example, suppose there are 2 filter functions, F1 and F2, and that F1's values range from −1 to +1, and F2's values range from 0 to 5. Then the reference space is the rectangle in the x/y plane with corners (−1,0), (1,0), (−1, 5), (1, 5), as every point s of S will give rise to a pair (F1(s), F2(s)) that lies within that rectangle.

In various embodiments, the cover of R is given by taking products of intervals of the covers of [min_k,max_k] for each of the k filters. In one example, if the user requests 2 intervals and a 50% overlap for F1, the cover of the interval [−1,+1] will be the two intervals (−1.5, 0.5), (−0.5, 1.5). If the user requests 5 intervals and a 30% overlap for F2, then that cover of [0, 5] will be (−0.3, 1.3), (0.7, 2.3), (1.7, 3.3), (2.7, 4.3), (3.7, 5.3). These intervals may give rise to a cover of the 2-dimensional box by taking all possible pairs of intervals where the first of the pair is chosen from the cover for F1 and the second from the cover for F2. This may give rise to 2*5, or 10, open boxes that covered the 2-dimensional reference space. However, those skilled in the art will appreciate that the intervals may not be uniform, or that the covers of a k-dimensional box may not be constructed by products of intervals. In some embodiments, there are many other choices of intervals. Further, in various embodiments, a wide range of covers and/or more general reference spaces may be used.

In one example, given a cover, C₁, . . . , Cₘ, of R, the reference map is used to assign a set of indices to each point in S, which are the indices of the Cⱼ such that ref(s) belongs to Cⱼ. This function may be called ref_tags(s). In a language such as Java, ref_tags would be a method that returned an int[ ]. Since the C's cover R in this example, ref(s) must lie in at least one of them, but the elements of the cover usually overlap one another, which means that points that “land near the edges” may well reside in multiple cover sets. In considering the two filter example, if F1(s) is −0.99, and F2(s) is 0.001, then ref(s) is (−0.99, 0.001), and this lies in the cover element (−1.5, 0.5)×(−0.3,1.3). Supposing that was labeled C₁, the reference map may assign s to the set {1}. On the other hand, if t is mapped by F1, F2 to (0.1, 2.1), then ref(t) will be in (−1.5,0.5)×(0.7, 2.3), (−0.5, 1.5)×(0.7,2.3), (−1.5,0.5)×(1.7,3.3), and (−0.5, 1.5)×(1.7,3.3), so the set of indices would have four elements for t.

Having computed, for each point, which “cover tags” it is assigned to, for each cover element, C_{d}, the points may be constructed, whose tags include d, as set S(d). This may mean that every point s is in S(d) for some d, but some points may belong to more than one such set. In some embodiments, there is, however, no requirement that each S(d) is non-empty, and it is frequently the case that some of these sets are empty. In the non-parallelized version of some embodiments, each point x is processed in turn, and x is inserted into a hash-bucket for each j in ref_tags(t) (that is, this may be how S(d) sets are computed).

Those skilled in the art will appreciate that the cover of the reference space R may be controlled by the number of intervals and the overlap identified in the resolution (e.g., see FIG. 7). For example, the more intervals, the finer the resolution in S—that is, the fewer points in each S(d), but the more similar (with respect to the filters) these points may be. The greater the overlap, the more times that clusters in S(d) may intersect clusters in S(e)—this means that more “relationships” between points may appear, but, in some embodiments, the greater the overlap, the more likely that accidental relationships may appear.

In step 810, the analysis module 220 clusters each S(d) based on the metric, filter, and the space S. In some embodiments, a dynamic single-linkage clustering algorithm may be used to partition S(d). Those skilled in the art will appreciate that any number of clustering algorithms may be used with embodiments discussed herein. For example, the clustering scheme may be k-means clustering for some k, single linkage clustering, average linkage clustering, or any method specified by the user.

The significance of the user-specified inputs may now be seen. In some embodiments, a filter may amount to a “forced stretching” in a certain direction. In some embodiments, the analysis module 220 may not cluster two points unless ALL of the filter values are sufficiently “related” (recall that while normally related may mean “close,” the cover may impose a much more general relationship on the filter values, such as relating two points s and t if ref(s) and ref(t) are sufficiently close to the same circle in the plane). In various embodiments, the ability of a user to impose one or more “critical measures” makes this technique more powerful than regular clustering, and the fact that these filters can be anything, is what makes it so general.

The output may be a simplicial complex, from which one can extract its 1-skeleton. The nodes of the complex may be partial clusters, (i.e., clusters constructed from subsets of S specified as the preimages of sets in the given covering of the reference space R).

In step 812, the visualization engine 222 identifies nodes which are associated with a subset of the partition elements of all of the S(d) for generating an interactive visualization. For example, suppose that S={1, 2, 3, 4}, and the cover is C₁, C₂, C₃. Then if ref_tags(1)={1, 2, 3} and ref_tags(2)={2, 3}, and ref_tags(3)={3}, and finally ref_tags(4)={1, 3}, then S(1) in this example is {1, 4}, S(2)={1,2}, and S(3)={1,2,3,4}. If 1 and 2 are close enough to be clustered, and 3 and 4 are, but nothing else, then the clustering for S(1) may be {1} {3}, and for S(2) it may be {1,2}, and for S(3) it may be {1,2}, {3,4}. So the generated graph has, in this example, at most four nodes, given by the sets {1}, {4}, {1,2}, and {3,4} (note that {1,2} appears in two different clusterings). Of the sets of points that are used, two nodes intersect provided that the associated node sets have a non-empty intersection (although this could easily be modified to allow users to require that the intersection is “large enough” either in absolute or relative terms).

Nodes may be eliminated for any number of reasons. For example, a node may be eliminated as having too few points and/or not being connected to anything else. In some embodiments, the criteria for the elimination of nodes (if any) may be under user control or have application-specific requirements imposed on it. For example, if the points are consumers, for instance, clusters with too few people in area codes served by a company could be eliminated. If a cluster was found with “enough” customers, however, this might indicate that expansion into area codes of the other consumers in the cluster could be warranted.

In step 814, the visualization engine 222 joins clusters to identify edges (e.g., connecting lines between nodes). Once the nodes are constructed, the intersections (e.g., edges) may be computed “all at once,” by computing, for each point, the set of node sets (not ref_tags, this time). That is, for each s in S, node_id_set(s) may be computed, which is an int[ ]. In some embodiments, if the cover is well behaved, then this operation is linear in the size of the set S, and we then iterate over each pair in node_id_set(s). There may be an edge between two node_id's if they both belong to the same node_id_set( ) value, and the number of points in the intersection is precisely the number of different node_id sets in which that pair is seen. This means that, except for the clustering step (which is often quadratic in the size of the sets S(d), but whose size may be controlled by the choice of cover), all of the other steps in the graph construction algorithm may be linear in the size of S, and may be computed quite efficiently.

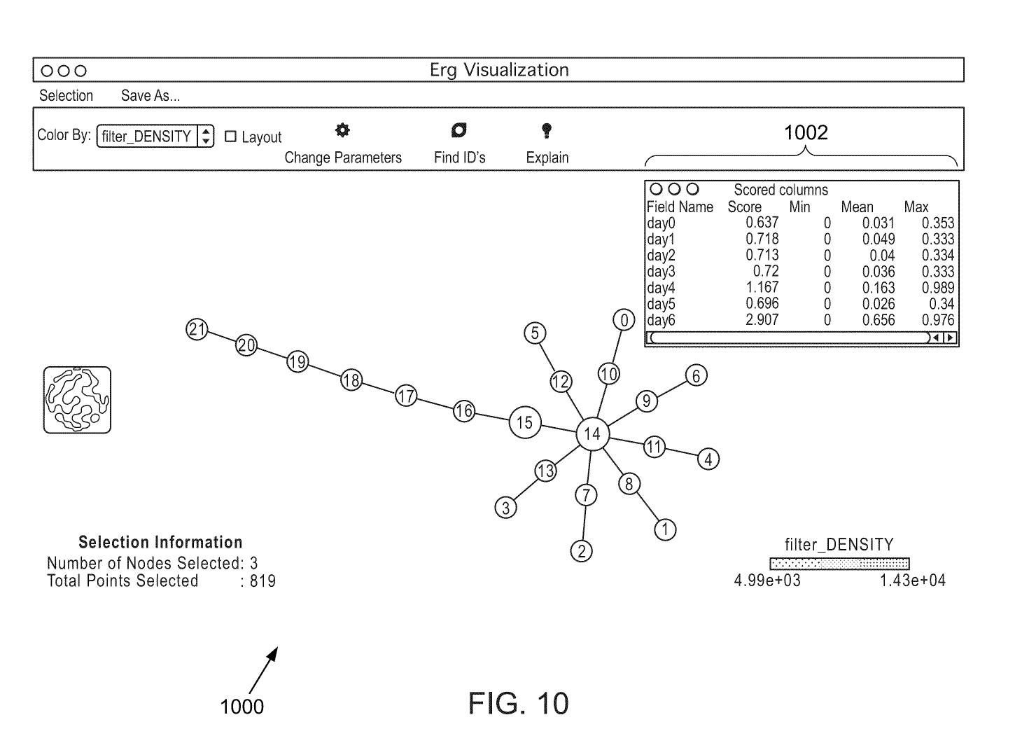

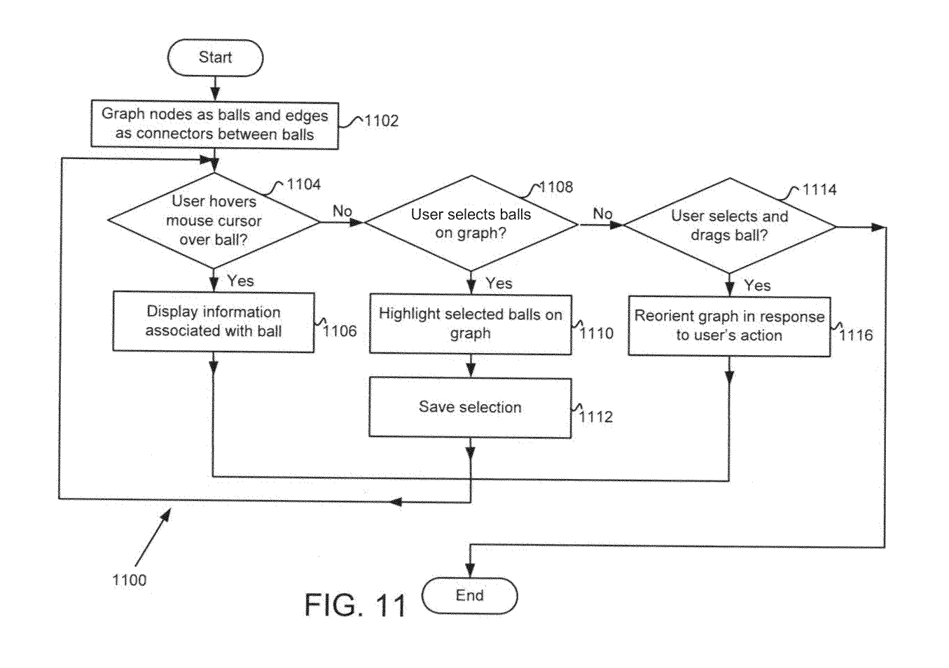

In step 816, the visualization engine 222 generates the interactive visualization of interconnected nodes (e.g., nodes and edges displayed in FIGS. 10 and 11).

Those skilled in the art will appreciate that it is possible, in some embodiments, to make sense in a fairly deep way of connections between various ref( ) maps and/or choices of clustering. Further, in addition to computing edges (pairs of nodes), the embodiments described herein may be extended to compute triples of nodes, etc. For example, the analysis module 220 may compute simplicial complexes of any dimension (by a variety of rules) on nodes, and apply techniques from homology theory to the graphs to help users understand a structure in an automatic (or semi-automatic) way.

Further, those skilled in the art will appreciate that uniform intervals in the covering may not always be a good choice. For example, if the points are exponentially distributed with respect to a given filter, uniform intervals can fail—in such case adaptive interval sizing may yield uniformly-sized S(d) sets, for instance.

Further, in various embodiments, an interface may be used to encode techniques for incorporating third-party extensions to data access and display techniques. Further, an interface may be used to for third-party extensions to underlying infrastructure to allow for new methods for generating coverings, and defining new reference spaces.

FIG. 9 is an exemplary interactive visualization 900 in some embodiments. The display of the interactive visualization may be considered a “graph” in the mathematical sense. The interactive visualization comprises of two types of objects: nodes (e.g., nodes 902 and 906) (the colored balls) and the edges (e.g., edge 904) (the black lines). The edges connect pairs of nodes (e.g., edge 904 connects node 902 with node 906). As discussed herein, each node may represent a collection of data points (rows in the database identified by the user). In one example, connected nodes tend to include data points which are “similar to” (e.g., clustered with) each other. The collection of data points may be referred to as being “in the node.” The interactive visualization may be two-dimensional, three-dimensional, or a combination of both.

In various embodiments, connected nodes and edges may form a graph or structure. There may be multiple graphs in the interactive visualization. In one example, the interactive visualization may display two or more unconnected structures of nodes and edges.

The visual properties of the nodes and edges (such as, but not limited to, color, stroke color, text, texture, shape, coordinates of the nodes on the screen) can encode any data based property of the data points within each node. For example, coloring of the nodes and/or the edges may indicate (but is not limited to) the following:
Values of fields or filters
Any general functions of the data in the nodes (e.g., if the data were unemployment rates by state, then GDP of the states may be identifiable by color the nodes)
Number of data points in the node

The interactive visualization 900 may contain a “color bar” 910 which may comprise a legend indicating the coloring of the nodes (e.g., balls) and may also identify what the colors indicate. For example, in FIG. 9, color bar 910 indicates that color is based on the density filter with blue (on the far left of the color bar 910) indicating “4.99e+03” and red (on the far right of the color bar 910) indicating “1.43e+04.” In general this might be expanded to show any other legend by which nodes and/or edges are colored. Those skilled in the art will appreciate that the, In some embodiments, the user may control the color as well as what the color (and/or stroke color, text, texture, shape, coordinates of the nodes on the screen) indicates.

The user may also drag and drop objects of the interactive visualization 900. In various embodiments, the user may reorient structures of nodes and edges by dragging one or more nodes to another portion of the interactive visualization (e.g., a window). In one example, the user may select node 902, hold node 902, and drag the node across the window. The node 902 will follow the user's cursor, dragging the structure of edges and/or nodes either directly or indirectly connected to the node 902. In some embodiments, the interactive visualization 900 may depict multiple unconnected structures. Each structure may include nodes, however, none of the nodes of either structure are connected to each other. If the user selects and drags a node of the first structure, only the first structure will be reoriented with respect to the user action. The other structure will remain unchanged. The user may wish to reorient the structure in order to view nodes, select nodes, and/or better understand the relationships of the underlying data.

In one example, a user may drag a node to reorient the interactive visualization (e.g., reorient the structure of nodes and edges). While the user selects and/or drags the node, the nodes of the structure associated with the selected node may move apart from each other in order to provide greater visibility. Once the user lets go (e.g., deselects or drops the node that was dragged), the nodes of the structure may continue to move apart from each other.

In various embodiments, once the visualization module 222 generates the interactive display, the depicted structures may move by spreading out the nodes from each other. In one example, the nodes spread from each other slowly allowing the user to view nodes distinguish from each other as well as the edges. In some embodiments, the visualization module 222 optimizes the spread of the nodes for the user's view. In one example, the structure(s) stop moving once an optimal view has been reached.

Those skilled in the art will appreciate that the interactive visualization 900 may respond to gestures (e.g., multitouch), stylus, or other interactions allowing the user to reorient nodes and edges and/or interacting with the underlying data.

The interactive visualization 900 may also respond to user actions such as when the user drags, clicks, or hovers a mouse cursor over a node. In some embodiments, when the user selects a node or edge, node information or edge information may be displayed. In one example, when a node is selected (e.g., clicked on by a user with a mouse or a mouse cursor hovers over the node), a node information box 908 may appear that indicates information regarding the selected node. In this example, the node information box 908 indicates an ID, box ID, number of elements (e.g., data points associated with the node), and density of the data associated with the node.

The user may also select multiple nodes and/or edges by clicking separate on each object, or drawing a shape (such as a box) around the desired objects. Once the objects are selected, a selection information box 912 may display some information regarding the selection. For example, selection information box 912 indicates the number of nodes selected and the total points (e.g., data points or elements) of the selected nodes.

The interactive visualization 900 may also allow a user to further interact with the display. Color option 914 allows the user to display different information based on color of the objects. Color option 914 in FIG. 9 is set to filter Density, however, other filters may be chosen and the objects re-colored based on the selection. Those skilled in the art will appreciate that the objects may be colored based on any filter, property of data, or characterization. When a new option is chosen in the color option 914, the information and/or colors depicted in the color bar 910 may be updated to reflect the change.

Layout checkbox 914 may allow the user to anchor the interactive visualization 900. In one example, the layout checkbox 914 is checked indicating that the interactive visualization 900 is anchored. As a result, the user will not be able to select and drag the node and/or related structure. Although other functions may still be available, the layout checkbox 914 may help the user keep from accidentally moving and/or reorienting nodes, edges, and/or related structures. Those skilled in the art will appreciate that the layout checkbox 914 may indicate that the interactive visualization 900 is anchored when the layout checkbox 914 is unchecked and that when the layout checkbox 914 is checked the interactive visualization 900 is no longer anchored.

The change parameters button 918 may allow a user to change the parameters (e.g., add/remove filters and/or change the resolution of one or more filters). In one example, when the change parameters button 918 is activated, the user may be directed back to the metric and filter selection interface window 600 (see FIG. 6) which allows the user to add or remove filters (or change the metric). The user may then view the filter parameter interface 700 (see FIG. 7) and change parameters (e.g., intervals and overlap) for one or more filters. The analysis node 220 may then re-analyze the data based on the changes and display a new interactive visualization 900 without again having to specify the data sets, filters, etc.

The find ID's button 920 may allow a user to search for data within the interactive visualization 900. In one example, the user may click the find ID's button 920 and receive a window allowing the user to identify data or identify a range of data. Data may be identified by ID or searching for the data based on properties of data and/or metadata. If data is found and selected, the interactive visualization 900 may highlight the nodes associated with the selected data. For example, selecting a single row or collection of rows of a database or spreadsheet may produce a highlighting of nodes whose corresponding partial cluster contains any element of that selection.

In various embodiments, the user may select one or more objects and click on the explain button 922 to receive in-depth information regarding the selection. In some embodiments, when the user selects the explain button 922, the information about the data from which the selection is based may be displayed. The function of the explain button 922 is further discussed with regard to FIG. 10.

In various embodiments, the interactive visualization 900 may allow the user to specify and identify subsets of interest, such as output filtering, to remove clusters or connections which are too small or otherwise uninteresting. Further, the interactive visualization 900 may provide more general coloring and display techniques, including, for example, allowing a user to highlight nodes based on a user-specified predicate, and coloring the nodes based on the intensity of user-specified weighting functions.

The interactive visualization 900 may comprise any number of menu items. The “Selection” menu may allow the following functions:
Select singletons (select nodes which are not connected to other nodes)
Select all (selects all the nodes and edges)
Select all nodes (selects all nodes)
Select all edges
Clear selection (no selection)
Invert Selection (selects the complementary set of nodes or edges)
Select “small” nodes (allows the user to threshold nodes based on how many points they have)
Select leaves (selects all nodes which are connected to long “chains” in the graph)
Remove selected nodes
Show in a table (shows the selected nodes and their associated data in a table)
Save selected nodes (saves the selected data to whatever format the user chooses. This may allow the user to subset the data and create new datasources which may be used for further analysis.)

In one example of the “show in a table” option, information from a selection of nodes may be displayed. The information may be specific to the origin of the data. In various embodiments, elements of a database table may be listed, however, other methods specified by the user may also be included. For example, in the case of microarray data from gene expression data, heat maps may be used to view the results of the selections.

The interactive visualization 900 may comprise any number of menu items. The “Save” menu may allow may allow the user to save the whole output in a variety of different formats such as (but not limited to):
Image files (PNG/JPG/PDF/SVG etc.)
Binary output (The interactive output is saved in the binary format. The user may reopen this file at any time to get this interactive window again)
   In some embodiments, graphs may be saved in a format such that the graphs may be used for presentations. This may include simply saving the image as a pdf or png file, but it may also mean saving an executable .xml file, which may permit other users to use the search and save capability to the database on the file without having to recreate the analysis.

In various embodiments, a relationship between a first and a second analysis output/interactive visualization for differing values of the interval length and overlap percentage may be displayed. The formal relationship between the first and second analysis output/interactive visualization may be that when one cover refines the next, there is a map of simplicial complexes from the output of the first to the output of the second. This can be displayed by applying a restricted form of a three-dimensional graph embedding algorithm, in which a graph is the union of the graphs for the various parameter values and in which the connections are the connections in the individual graphs as well as connections from one node to its image in the following graph. The constituent graphs may be placed in its own plane in 3D space. In some embodiments, there is a restriction that each constituent graph remain within its associated plane. Each constituent graph may be displayed individually, but a small change of parameter value may result in the visualization of the adjacent constituent graph. In some embodiments, nodes in the initial graph will move to nodes in the next graph, in a readily visualizable way.

FIG. 10 is an exemplary interactive visualization 1000 displaying an explain information window 1002 in some embodiments. In various embodiments, the user may select a plurality of nodes and click on the explain button. When the explain button is clicked, the explain information window 1002 may be generated. The explain information window 1002 may identify the data associated with the selected object(s) as well as information (e.g., statistical information) associated with the data.

In some embodiments, the explain button allows the user to get a sense for which fields within the selected data fields are responsible for “similarity” of data in the selected nodes and the differentiating characteristics. There can be many ways of scoring the data fields. The explain information window 1002 (i.e., the scoring window in FIG. 10) is shown along with the selected nodes. The highest scoring fields may distinguish variables with respect to the rest of the data.

In one example, the explain information window 1002 indicates that data from fields day0-day6 has been selected. The minimum value of the data in all of the fields is 0. The explain information window 1002 also indicates the maximum values. For example, the maximum value of all of the data associated with the day0 field across all of the points of the selected nodes is 0.353. The average (i.e., mean) of all of the data associated with the day0 field across all of the points of the selected nodes is 0.031. The score may be a relative (e.g., normalized) value indicating the relative function of the filter; here, the score may indicate the relative density of the data associated with the day0 field across all of the points of the selected nodes. Those skilled in the art will appreciate that any information regarding the data and/or selected nodes may appear in the explain information window 1002.

Those skilled in the art will appreciate that the data and the interactive visualization 1000 may be interacted with in any number of ways. The user may interact with the data directly to see where the graph corresponds to the data, make changes to the analysis and view the changes in the graph, modify the graph and view changes to the data, or perform any kind of interaction.

FIG. 11 is a flowchart 1100 of functionality of the interactive visualization in some embodiments. In step 1102, the visualization engine 222 receives the analysis from the analysis module 220 and graphs nodes as balls and edges as connectors between balls 1102 to create interactive visualization 900 (see FIG. 9).

In step 1104, the visualization engine 222 determines if the user is hovering a mouse cursor (or has selected) a ball (i.e., a node). If the user is hovering a mouse cursor over a ball or selecting a ball, then information is displayed regarding the data associated with the ball. In one example, the visualization engine 222 displays a node information window 908.

If the visualization engine 222 does not determine that the user is hovering a mouse cursor (or has selected) a ball, then the visualization engine 222 determines if the user has selected balls on the graph (e.g., by clicking on a plurality of balls or drawing a box around a plurality of balls). If the user has selected balls on the graph, the visualization engine 222 may highlight the selected balls on the graph in step 1110. The visualization engine 222 may also display information regarding the selection (e.g., by displaying a selection information window 912). The user may also click on the explain button 922 to receive more information associated with the selection (e.g., the visualization engine 222 may display the explain information window 1002).

In step 1112, the user may save the selection. For example, the visualization engine 222 may save the underlying data, selected metric, filters, and/or resolution. The user may then access the saved information and create a new structure in another interactive visualization 900 thereby allowing the user to focus attention on a subset of the data.

If the visualization engine 222 does not determine that the user has selected balls on the graph, the visualization engine 222 may determine if the user selects and drags a ball on the graph in step 1114. If the user selects and drags a ball on the graph, the visualization engine 222 may reorient the selected balls and any connected edges and balls based on the user's action in step 1116. The user may reorient all or part of the structure at any level of granularity.

Those skilled in the art will appreciate that although FIG. 11 discussed the user hovering over, selecting, and/or dragging a ball, the user may interact with any object in the interactive visualization 900 (e.g., the user may hover over, select, and/or drag an edge). The user may also zoom in or zoom out using the interactive visualization 900 to focus on all or a part of the structure (e.g., one or more balls and/or edges).

Further, although balls are discussed and depicted in FIGS. 9-11, those skilled in the art will appreciate that the nodes may be any shape and appear as any kind of object. Further, although some embodiments described herein discuss an interactive visualization being generated based on the output of algebraic topology, the interactive visualization may be generated based on any kind of analysis and is not limited.

For years, researchers have been collecting huge amounts of data on breast cancer, yet we are still battling the disease. Complexity, rather than quantity, is one of the fundamental issues in extracting knowledge from data. A topological data exploration and visualization platform may assist the analysis and assessment of complex data. In various embodiments, a predictive and visual cancer map generated by the topological data exploration and visualization platform may assist physicians to determine treatment options.

In one example, a breast cancer map visualization may be generated based on the large amount of available information already generated by many researchers. Physicians may send biopsy data directly to a cloud-based server which may localize a new patient's data within the breast cancer map visualization. The breast cancer map visualization may be annotated (e.g., labeled) such that the physician may view outcomes of patients with similar profiles as well as different kinds of statistical information such as survival probabilities. Each new data point from a patient may be incorporated into the breast cancer map visualization to improve accuracy of the breast cancer map visualization over time.

Although the following examples are largely focused on cancer map visualizations, those skilled in the art will appreciate that at least some of the embodiments described herein may apply to any biological condition and not be limited to cancer and/or disease. For example, some embodiments, may apply to different industries.

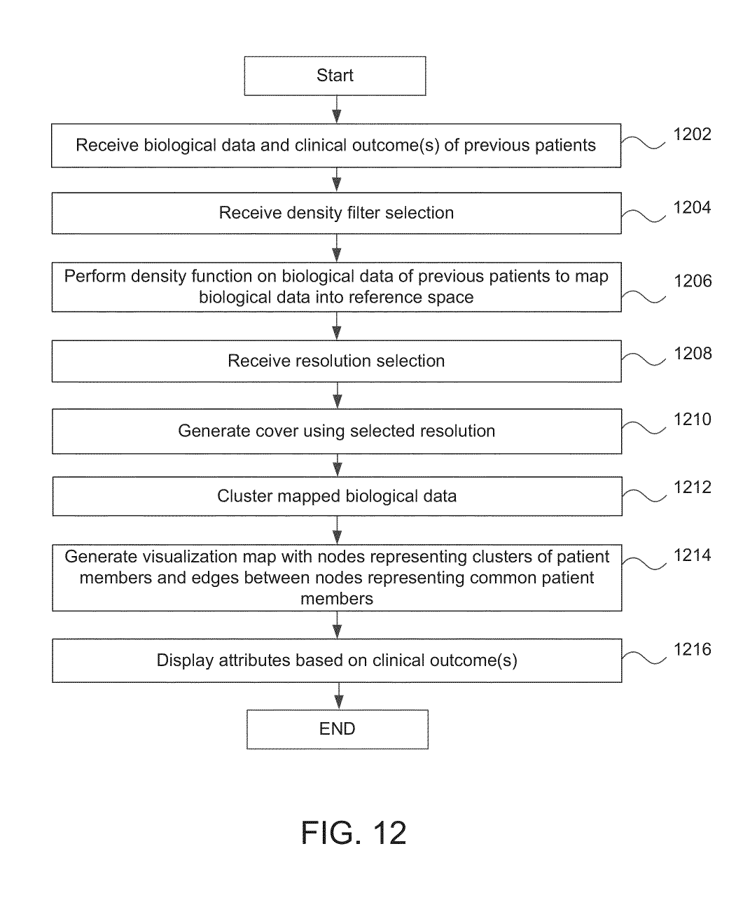

FIG. 12 is a flowchart for generating a cancer map visualization utilizing biological data of a plurality of patients in some embodiments. In various embodiments, the processing of data and user-specified options is motivated by techniques from topology and, in some embodiments, algebraic topology. As discussed herein, these techniques may be robust and general. In one example, these techniques apply to almost any kind of data for which some qualitative idea of “closeness” or “similarity” exists. Those skilled in the art will appreciate that the implementation of techniques described herein may apply to any level of generality.

In various embodiments, a cancer map visualization is generated using genomic data linked to clinical outcomes (i.e., medical characteristics) which may be used by physicians during diagnosis and/or treatment. Initially, publicly available data sets may be integrated to construct the topological map visualizations of patients (e.g., breast cancer patients). Those skilled in the art will appreciate that any private, public, or combination of private and public data sets may be integrated to construct the topological map visualizations. A map visualization may be based on biological data such as, but not limited to, gene expression, sequencing, and copy number variation. As such, the map visualization may comprise many patients with many different types of collected data. Unlike traditional methods of analysis where distinct studies of breast cancer appear as separate entities, the map visualization may fuse disparate data sets while utilizing many datasets and data types.

In various embodiments, a new patient may be localized on the map visualization. With the map visualization for subtypes of a particular disease and a new patient diagnosed with the disease, point(s) may be located among the data points used in computing the map visualization (e.g., nearest neighbor) which is closest to the new patient point. The new patient may be labeled with nodes in the map visualization containing the closest neighbor. These nodes may be highlighted to give a physician the location of the new patient among the patients in the reference data set. The highlighted nodes may also give the physician the location of the new patient relative to annotated disease subtypes.

The visualization map may be interactive and/or searchable in real-time thereby potentially enabling extended analysis and providing speedy insight into treatment.

In step 1202, biological data and clinical outcomes of previous patients may be received. The clinical outcomes may be medical characteristics. Biological data is any data that may represent a condition (e.g., a medical condition) of a person. Biological data may include any health related, medical, physical, physiological, pharmaceutical data associated with one or more patients. In one example, biological data may include measurements of gene expressions for any number of genes. In another example, biological data may include sequencing information (e.g., RNA sequencing).

In various embodiments, biological data for a plurality of patients may be publicly available. For example, various medical health facilities and/or public entities may provide gene expression data for a variety of patients. In addition to the biological data, information regarding any number of clinical outcomes, treatments, therapies, diagnoses and/or prognoses may also be provided. Those skilled in the art will appreciate that any kind of information may be provided in addition to the biological data.

The biological data, in one example, may be similar to data S as discussed with regard to step 802 of FIG. 8. The biological data may include ID fields that identify patients and data fields that are related to the biological information (e.g., gene expression measurements).

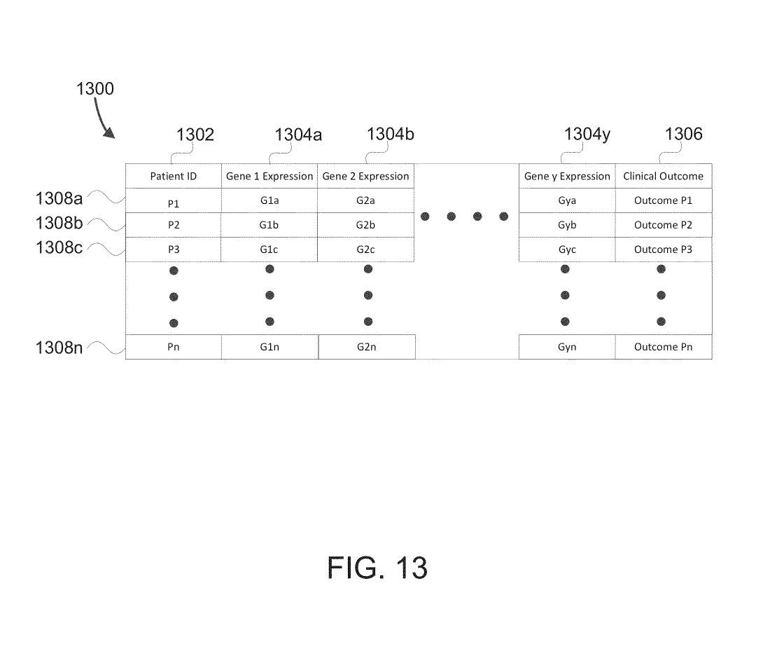

FIG. 13 is an exemplary data structure 1302 including biological data 1304a-1304y for a number of patients 1308a-1308n that may be used to generate the cancer map visualization in some embodiments. Column 1302 represents different patient identifiers for different patients. The patient identifiers may be any identifier.

At least some biological data may be contained within gene expression measurements 1304a-1304y. In FIG. 13, “y” represents any number. For example, there may be 50,000 or more separate columns for different gene expressions related to a single patient or related to one or more samples from a patient. Those skilled in the art will appreciate that column 1304a may represent a gene expression measurement for each patient (if any for some patients) associated with the patient identifiers in column 1302. The column 1304b may represent a gene expression measurement of one or more genes that are different than that of column 1304a. As discussed, there may be any number of columns representing different gene expression measurements.

Column 1306 may include any number of clinical outcomes, prognoses, diagnoses, reactions, treatments, and/or any other information associated with each patient. All or some of the information contained in column 1306 may be displayed (e.g., by a label or an annotation that is displayed on the visualization or available to the user of the visualization via clicking) on or for the visualization.

Rows 1308a-1308n each contains biological data associated with the patient identifier of the row. For example, gene expressions in row 1308a are associated with patient identifier P1. As similarly discussed with regard to “y” herein, “n” represents any number. For example, there may be 100,000 or more separate rows for different patients.

Those skilled in the art will appreciate that there may be any number of data structures that contain any amount of biological data for any number of patients. The data structure(s) may be utilized to generate any number of map visualizations.

In step 1204, the analysis server may receive a filter selection. In some embodiments, the filter selection is a density estimation function. Those skilled in the art will appreciate that the filter selection may include a selection of one or more functions to generate a reference space.

In step 1206, the analysis server performs the selected filter(s) on the biological data of the previous patients to map the biological data into a reference space. In one example, a density estimation function, which is well known in the art, may be performed on the biological data (e.g., data associated with gene expression measurement data 1304a-1304y) to relate each patient identifier to one or more locations in the reference space (e.g., on a real line).

In step 1208, the analysis server may receive a resolution selection. The resolution may be utilized to identify overlapping portions of the reference space (e.g., a cover of the reference space R) in step 1210.

As discussed herein, the cover of R may be a finite collection of open sets (in the metric of R) such that every point in R lies in at least one of these sets. In various examples, R is k-dimensional Euclidean space, where k is the number of filter functions. Those skilled in the art will appreciate that the cover of the reference space R may be controlled by the number of intervals and the overlap identified in the resolution (e.g., see FIG. 7). For example, the more intervals, the finer the resolution in S (e.g., the similarity space of the received biological data)—that is, the fewer points in each S(d), but the more similar (with respect to the filters) these points may be. The greater the overlap, the more times that clusters in S(d) may intersect clusters in S(e)—this means that more “relationships” between points may appear, but, in some embodiments, the greater the overlap, the more likely that accidental relationships may appear.

In step 1212, the analysis server receives a metric to cluster the information of the cover in the reference space to partition S(d). In one example, the metric may be a Pearson Correlation. The clusters may form the groupings (e.g., nodes or balls). Various cluster means may be used including, but not limited to, a single linkage, average linkage, complete linkage, or k-means method.

As discussed herein, in some embodiments, the analysis module 220 may not cluster two points unless filter values are sufficiently “related” (recall that while normally related may mean “close,” the cover may impose a much more general relationship on the filter values, such as relating two points s and t if ref(s) and ref(t) are sufficiently close to the same circle in the plane where ref( ) represents one or more filter functions). The output may be a simplicial complex, from which one can extract its 1-skeleton. The nodes of the complex may be partial clusters, (i.e., clusters constructed from subsets of S specified as the preimages of sets in the given covering of the reference space R).

In step 1214, the analysis server may generate the visualization map with nodes representing clusters of patient members and edges between nodes representing common patient members. In one example, the analysis server identifies nodes which are associated with a subset of the partition elements of all of the S(d) for generating an interactive visualization.

As discussed herein, for example, suppose that S={1, 2, 3, 4}, and the cover is C₁, C₂, C₃. Suppose cover C₁ contains {1, 4}, C₂ contains {1,2}, and C₃ contains {1,2,3,4}. If 1 and 2 are close enough to be clustered, and 3 and 4 are, but nothing else, then the clustering for S(1) may be {1}, {4}, and for S(2) it may be {1,2}, and for S(3) it may be {1,2}, {3,4}. So the generated graph has, in this example, at most four nodes, given by the sets {1}, {4}, {1, 2}, and {3, 4} (note that {1, 2} appears in two different clusterings). Of the sets of points that are used, two nodes intersect provided that the associated node sets have a non-empty intersection (although this could easily be modified to allow users to require that the intersection is “large enough” either in absolute or relative terms).

As a result of clustering, member patients of a grouping may share biological similarities (e.g., similarities based on the biological data).

The analysis server may join clusters to identify edges (e.g., connecting lines between nodes). Clusters joined by edges (i.e., interconnections) share one or more member patients. In step 1216, a display may display a visualization map with attributes based on the clinical outcomes contained in the data structures (e.g., see FIG. 13 regarding clinical outcomes). Any labels or annotations may be utilized based on information contained in the data structures. For example, treatments, prognoses, therapies, diagnoses, and the like may be used to label the visualization. In some embodiments, the physician or other user of the map visualization accesses the annotations or labels by interacting with the map visualization.

The resulting cancer map visualization may reveal interactions and relationships that were obscured, untested, and/or previously not recognized.

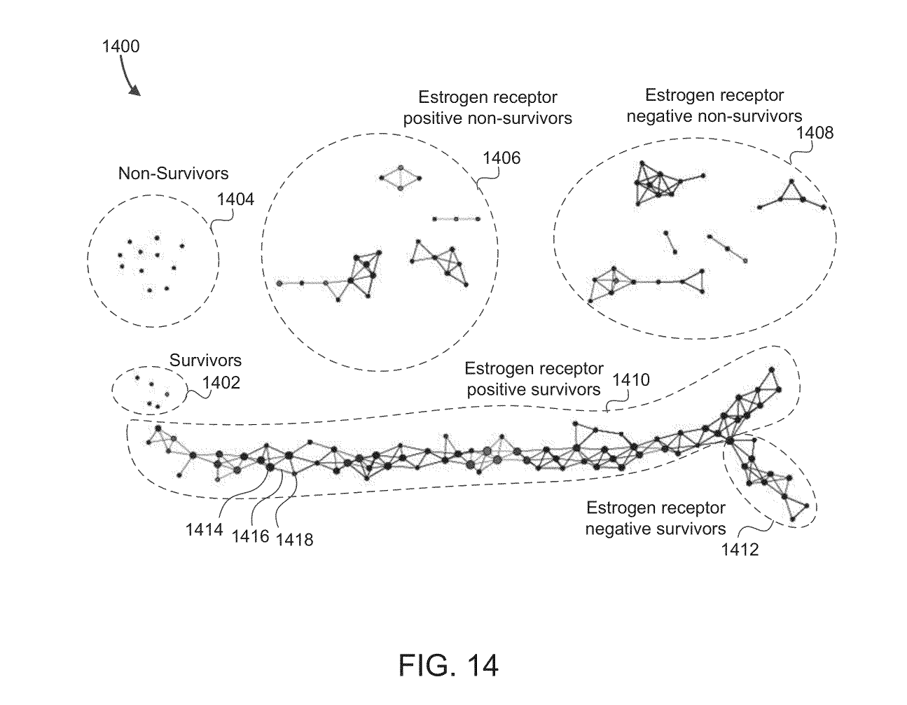

FIG. 14 is an exemplary visualization displaying the cancer map visualization 1400 in some embodiments. The cancer map visualization 1400 represents a topological network of cancer patients. The cancer map visualization 1400 may be based on publicly and/or privately available data.

In various embodiments, the cancer map visualization 1400 is created using gene expression profiles of excised tumors. Each node (i.e., ball or grouping displayed in the map visualization 1400) contains a subset of patients with similar genetic profiles.

As discussed herein, one or more patients (i.e., patient members of each node or grouping) may occur in multiple nodes. A patient may share a similar genetic profile with multiple nodes or multiple groupings. In one example, of 50,000 different gene expressions of the biological data, multiple patients may share a different genetic profiles (e.g., based on different gene expression combinations) with different groupings. When a patient shares a similar genetic profile with different groupings or nodes, the patient may be included within the groupings or nodes.

The cancer map visualization 1400 comprises groupings and interconnections that are associated with different clinical outcomes. All or some of the clinical outcomes may be associated with the biological data that generated the cancer map visualization 1400. The cancer map visualization 1400 includes groupings associated with survivors 1402 and groupings associated with non-survivors 1404. The cancer map visualization 1400 also includes different groupings associated with estrogen receptor positive non-survivors 1406, estrogen receptor negative non-survivors 1408, estrogen receptor positive survivors 1410, and estrogen receptor negative survivors 1412.

In various embodiments, when one or more patients are members of two or more different nodes, the nodes are interconnected by an edge (e.g., a line or interconnection). If there is not an edge between the two nodes, then there are no common member patients between the two nodes. For example, grouping 1414 shares at least one common member patient with grouping 1418. The intersection of the two groupings is represented by edge 1416. As discussed herein, the number of shared member patients of the two groupings may be represented in any number of ways including color of the interconnection, color of the groupings, size of the interconnection, size of the groupings, animations of the interconnection, animations of the groupings, brightness, or the like. In some embodiments, the number and/or identifiers of shared member patients of the two groupings may be available if the user interacts with the groupings 1414 and/or 1418 (e.g., draws a box around the two groupings and the interconnection utilizing an input device such as a mouse).

In various embodiments, a physician, on obtaining some data on a breast tumor, direct the data to an analysis server (e.g., analysis server 108 over a network such as the Internet) which may localize the patient relative to one or more groupings on the cancer map visualization 1400. The context of the cancer map visualization 1400 may enable the physician to assess various possible outcomes (e.g., proximity of representation of new patient to the different associations of clinical outcomes).

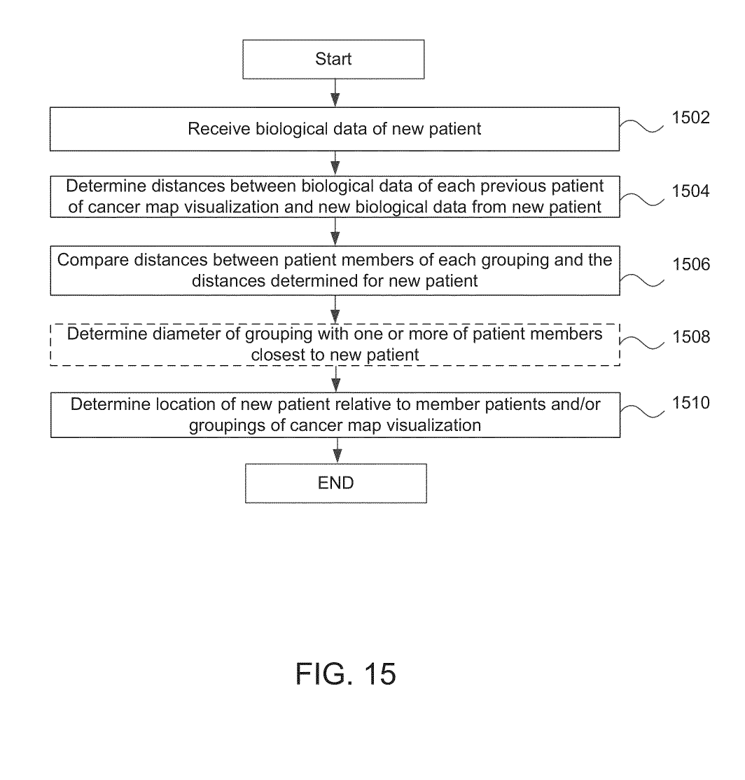

FIG. 15 is a flowchart of for positioning new patient data relative to a cancer map visualization in some embodiments. In step 1502, new biological data of a new patient is received. In various embodiments, an input module 214 of an analysis server (e.g., analysis server 108 of FIGS. 1 and 2) may receive biological data of a new patient from a physician or medical facility that performed analysis of one or more samples to generate the biological data. The biological data may be any data that represents a biological data of the new patient including, for example, gene expressions, sequencing information, or the like.

In some embodiments, the analysis server 108 may comprise a new patient distance module and a location engine. In step 1504, the new patient distance module determines distances between the biological data of each patient of the cancer map visualization 1600 and the new biological data from the new patient. For example, the previous biological data that was utilized in the generation of the cancer map visualization 1600 may be stored in mapped data structures. Distances may be determined between the new biological data of the new patient and each of the previous patient's biological data in the mapped data structure.

Those skilled in the art will appreciate that distances may be determined in any number of ways using any number of different metrics or functions. Distances may be determined between the biological data of the previous patients and the new patients. For example, a distance may be determined between a first gene expression measurement of the new patient and each (or a subset) of the first gene expression measurements of the previous patients (e.g., the distance between G1 of the new patient and G1 of each previous patient may be calculated). Distances may be determined between all (or a subset of) other gene expression measurements of the new patient to the gene expression measurements of the previous patients.

In various embodiments, a location of the new patient on the cancer map visualization 1600 may be determined relative to the other member patients utilizing the determined distances.

In step 1506, the new patient distance module may compare distances between the patient members of each grouping to the distances determined for the new patient. The new patient may be located in the grouping of patient members that are closest in distance to the new patient. In some embodiments, the new patient location may be determined to be within a grouping that contains the one or more patient members that are closest to the new patient (even if other members of the grouping have longer distances with the new patient). In some embodiments, this step is optional.

In various embodiments, a representative patient member may be determined for each grouping. For example, some or all of the patient members of a grouping may be averaged or otherwise combined to generate a representative patient member of the grouping (e.g., the distances and/or biological data of the patient members may be averaged or aggregated). Distances may be determined between the new patient biological data and the averaged or combined biological data of one or more representative patient members of one or more groupings. The location engine may determine the location of the new patient based on the distances. In some embodiments, once the closest distance between the new patient and the representative patient member is found, distances may be determined between the new patient and the individual patient members of the grouping associated with the closest representative patient member.

In optional step 1508, a diameter of the grouping with the one or more of the patient members that are closest to the new patient (based on the determined distances) may be determined. In one example, the diameters of the groupings of patient members closest to the new patient are calculated. The diameter of the grouping may be a distance between two patient members who are the farthest from each other when compared to the distances between all patient members of the grouping. If the distance between the new patient and the closest patient member of the grouping is less than the diameter of the grouping, the new patient may be located within the grouping. If the distance between the new patient and the closest patient member of the grouping is greater than the diameter of the grouping, the new patient may be outside the grouping (e.g., a new grouping may be displayed on the cancer map visualization with the new patient as the single patient member of the grouping). If the distance between the new patient and the closest patient member of the grouping is equal to the diameter of the grouping, the new patient may be placed within or outside the grouping.

It will be appreciated that the determination of the diameter of the grouping is not required in determining whether the new patient location is within or outside of a grouping. In various embodiments, a distribution of distances between member patients and between member patients and the new patient is determined. The decision to locate the new patient within or outside of the grouping may be based on the distribution. For example, if there is a gap in the distribution of distances, the new patient may be separated from the grouping (e.g., as a new grouping). In some embodiments, if the gap is greater than a preexisting threshold (e.g., established by the physician, other user, or previously programmed), the new patient may be placed in a new grouping that is placed relative to the grouping of the closest member patients. The process of calculating the distribution of distances of candidate member patients to determine whether there may be two or more groupings may be utilized in generation of the cancer map visualization (e.g., in the process as described with regard to FIG. 12). Those skilled in the art will appreciate that there may be any number of ways to determine whether a new patient should be included within a grouping of other patient members.

In step 1510, the location engine determines the location of the new patient relative to the member patients and/or groupings of the cancer map visualization. The new location may be relative to the determined distances between the new patient and the previous patients. The location of the new patient may be part of a previously existing grouping or may form a new grouping.

In some embodiments, the location of the new patient with regard to the cancer map visualization may be performed locally to the physician. For example, the cancer map visualization 1400 may be provided to the physician (e.g., via digital device). The physician may load the new patient's biological data locally and the distances may be determined locally or via a cloud-based server. The location(s) associated with the new patient may be overlaid on the previously existing cancer map visualization either locally or remotely.

Those skilled in the art will appreciate that, in some embodiments, the previous state of the cancer map visualization (e.g., cancer map visualization 1400) may be retained or otherwise stored and a new cancer map visualization generated utilizing the new patient biological data (e.g., in a method similar to that discussed with regard to FIG. 12). The newly generated map may be compared to the previous state and the differences may be highlighted thereby, in some embodiments, highlighting the location(s) associated with the new patient. In this way, distances may be not be calculated as described with regard to FIG. 15, but rather, the process may be similar to that as previously discussed.

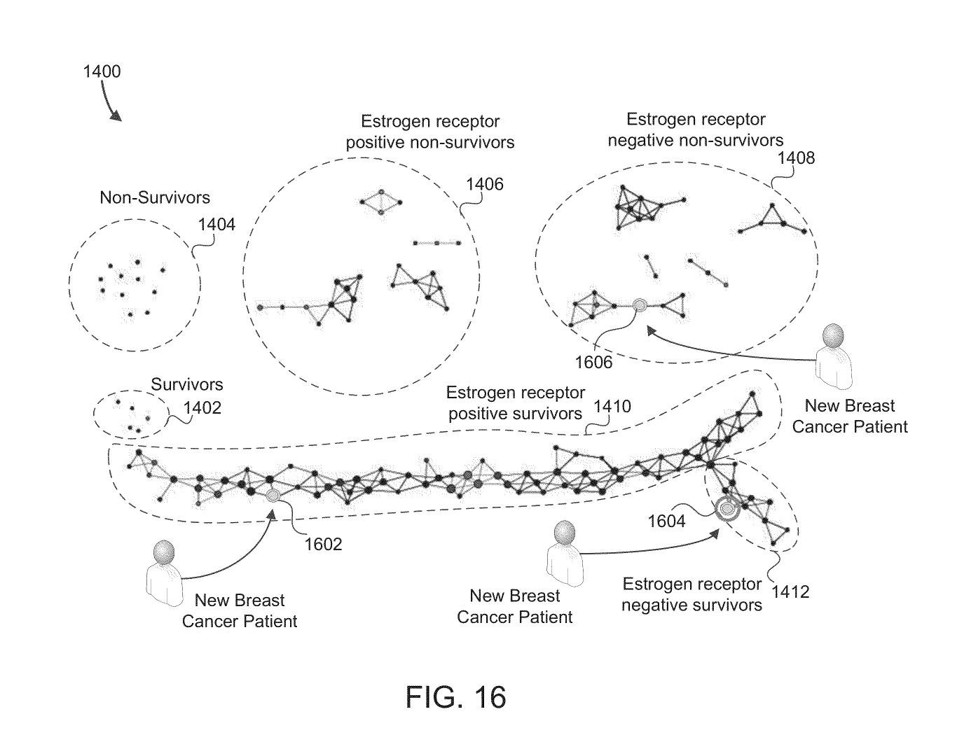

FIG. 16 is an exemplary visualization displaying the cancer map including positions for three new cancer patients in some embodiments. The cancer map visualization 1400 comprises groupings and interconnections that are associated with different clinical outcomes as discussed with regard to FIG. 14. All or some of the clinical outcomes may be associated with the biological data that generated the cancer map visualization 1400. The cancer map visualization 1400 includes different groupings associated with survivors 1402, groupings associated with non-survivors 1404, estrogen receptor positive non-survivors 1406, estrogen receptor negative non-survivors 1408, estrogen receptor positive survivors 1410, and estrogen receptor negative survivors 1412.

The cancer map visualization 1400 includes three locations for three new breast cancer patients. The breast cancer patient location 1602 is associated with the clinical outcome of estrogen receptor positive survivors. The breast cancer patient location 1604 is associated with the clinical outcome of estrogen receptor negative survivors. Unfortunately, breast cancer patient location 1606 is associated with estrogen receptor negative non-survivors. Based on the locations, a physician may consider different diagnoses, prognoses, treatments, and therapies to maintain or attempt to move the breast cancer patient to a different location utilizing the cancer map visualization 1400.

In some embodiments, the physician may assess the underlying biological data associated with any number of member patients of any number of groupings to better understand the genetic similarities and/or dissimilarities. The physician may utilize the information to make better informed decisions.

The patient location 1604 is highlighted on the cancer map visualization 1400 as active (e.g., selected by the physician). Those skilled in the art will appreciate that the different locations may be of any color, size, brightness, and/or animated to highlight the desired location(s) for the physician. Further, although only one location is identified for three different breast cancer patients, any of the breast cancer patients may have multiple locations indicating different genetic similarities.

Those skilled in the art will appreciate that the cancer map visualization 1400 may be updated with new information at any time. As such, as new patients are added to the cancer map visualization 1400, the new data updates the visualization such that as future patients are placed in the map, the map may already include the updated information. As new information and/or new patient data is added to the cancer map visualization 1400, the cancer map visualization 1400 may improve as a tool to better inform physicians or other medical professionals.

In various embodiments, the cancer map visualization 1400 may track changes in patients over time. For example, updates to a new patient may be visually tracked as changes in are measured in the new patient's biological data. In some embodiments, previous patient data is similarly tracked which may be used to determine similarities of changes based on condition, treatment, and/or therapies, for example. In various embodiments, velocity of change and/or acceleration of change of any number of patients may be tracked over time using or as depicted on the cancer map visualization 1400. Such depictions may assist the treating physician or other personnel related to the treating physician to better understand changes in the patient and provide improved, current, and/or updated diagnoses, prognoses, treatments, and/or therapies.

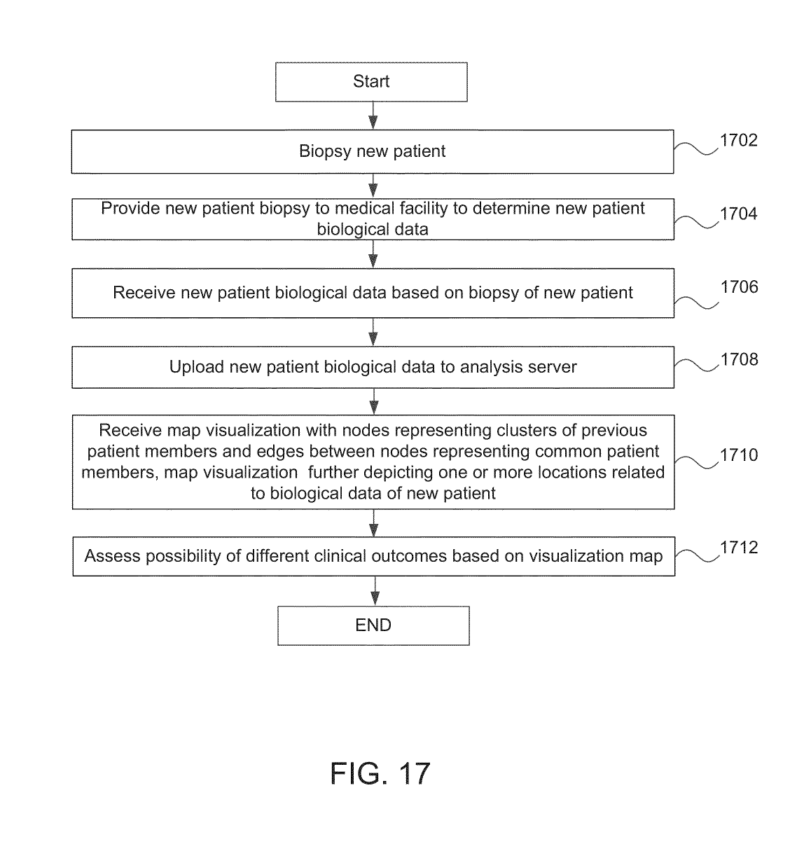

FIG. 17 is a flowchart of utilization the visualization and positioning of new patient data in some embodiments. In various embodiments, a physician may collect amounts of genomic information from tumors removed from a new patient, input the data (e.g., upload the data to an analysis server), and receive a map visualization with a location of the new patient. The new patient's location within the map may offer the physician new information about the similarities to other patients. In some embodiments, the map visualization may be annotated so that the physician may check the outcomes of previous patients in a given region of the map visualization are distributed and then use the information to assist in decision-making for diagnosis, treatment, prognosis, and/or therapy.

In step 1702, a medical professional or other personnel may remove a sample from a patient. The sample may be of a tumor, blood, or any other biological material. In one example, a medical professional performs a tumor excision. Any number of samples may be taken from a patient.

In step 1704, the sample(s) may be provided to a medical facility to determine new patient biological data. In one example, the medical facility measures genomic data such as gene expression of a number of genes or protein levels.

In step 1706, the medical professional or other entity associated with the medical professional may receive the new patient biological data based on the sample(s) from the new patient. In one example, a physician may receive the new patient biological data. The physician may provide all or some of the new patient biological data to an analysis server over the Internet (e.g., the analysis server may be a cloud-based server). In some embodiments, the analysis server is the analysis server 108 of FIG. 1. In some embodiments, the medical facility that determines the new patient biological data provides the biological data in an electronic format which may be uploaded to the analysis server. In some embodiments, the medical facility that determines the new patient biological data (e.g., the medical facility that measures the genomic data) provide the biological data to the analysis server at the request of the physician or others associated with the physician. Those skilled in the art will appreciate that the biological data may be provided to the analysis server in any number of ways.

The analysis server may be any digital device and may not be limited to a digital device on a network. In some embodiments, the physician may have access to the digital device. For example, the analysis server may be a table, personal computer, local server, or any other digital device.

Once the analysis server receives the biological data of the new patient, the new patient may be localized in the map visualization and the information may be sent back to the physician in step 1708. The visualization may be a map with nodes representing clusters of previous patient members and edges between nodes representing common patient members. The visualization may further depict one or more locations related to the biological data of the new patient.

The map visualization may be provided to the physician or other associated with the physician in real-time. For example, once the biological data associated with the new patient is provided to the analysis server, the analysis server may provide the map visualization back to the physician or other associated with the physician within a reasonably short time (e.g., within seconds or minutes). In some embodiments, the physician may receive the map visualization over any time.

The map visualization may be provided to the physician in any number of ways. For example, the physician may receive the map visualization over any digital device such as, but not limited to, an office computer, Ipad, tablet device, media device, smartphone, e-reader, or laptop.

In step 1710, the physician may assess possible different clinical outcomes based on the map visualization. In one example, the map-aided physician may make decisions on therapy and treatments depending on where the patient lands on the visualization (e.g., survivor or non-survivor). The map visualization may include annotations or labels that identify one or more sets of groupings and interconnections as being associated with one or more clinical outcomes. The physician may assess possible clinical outcomes based on the position(s) on the map associated with the new patient.

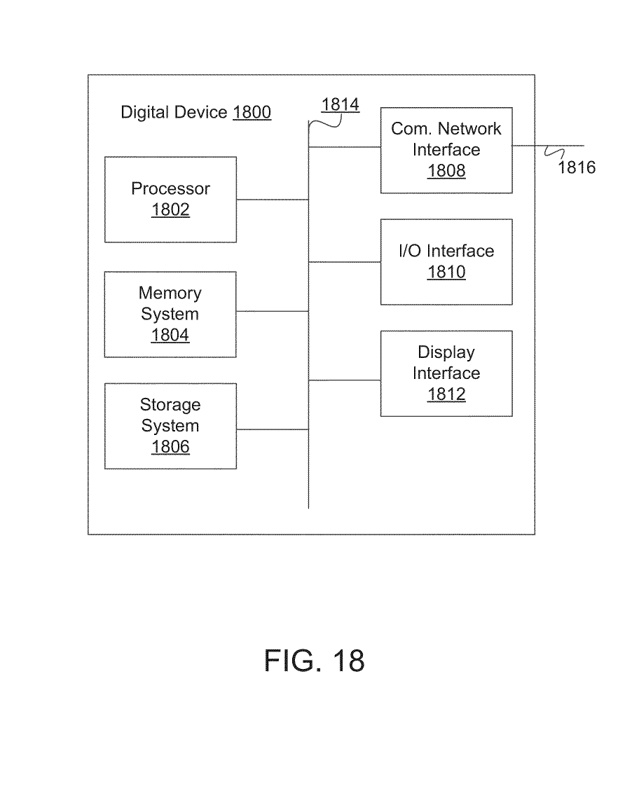

FIG. 18 is a block diagram of an exemplary digital device 1800. The digital device 1800 comprises a processor 1802, a memory system 1804, a storage system 1806, a communication network interface 1808, an I/O interface 1810, and a display interface 1812 communicatively coupled to a bus 1814. The processor 1802 may be configured to execute executable instructions (e.g., programs). In some embodiments, the processor 1802 comprises circuitry or any processor capable of processing the executable instructions.

The memory system 1804 is any memory configured to store data. Some examples of the memory system 1804 are storage devices, such as RAM or ROM. The memory system 1804 can comprise the ram cache. In various embodiments, data is stored within the memory system 1804. The data within the memory system 1804 may be cleared or ultimately transferred to the storage system 1806.

The storage system 1806 is any storage configured to retrieve and store data. Some examples of the storage system 1806 are flash drives, hard drives, optical drives, and/or magnetic tape. In some embodiments, the digital device 1800 includes a memory system 1804 in the form of RAM and a storage system 1806 in the form of flash data. Both the memory system 1804 and the storage system 1806 comprise computer readable media which may store instructions or programs that are executable by a computer processor including the processor 1802.

The communication network interface (com. network interface) 1808 can be coupled to a data network (e.g., data network 504 or 514) via the link 1816. The communication network interface 1808 may support communication over an Ethernet connection, a serial connection, a parallel connection, or an ATA connection, for example. The communication network interface 1808 may also support wireless communication (e.g., 1802.11 a/b/g/n, WiMax). It will be apparent to those skilled in the art that the communication network interface 1808 can support many wired and wireless standards.

The optional input/output (I/O) interface 1810 is any device that receives input from the user and output data. The optional display interface 1812 is any device that may be configured to output graphics and data to a display. In one example, the display interface 1812 is a graphics adapter.

It will be appreciated by those skilled in the art that the hardware elements of the digital device 1800 are not limited to those depicted in FIG. 18. A digital device 1800 may comprise more or less hardware elements than those depicted. Further, hardware elements may share functionality and still be within various embodiments described herein. In one example, encoding and/or decoding may be performed by the processor 1802 and/or a co-processor located on a GPU.

Many of the examples and embodiments discussed herein are with regard to a topological data exploration and visualization platform may assist the analysis and assessment of complex data. In some examples discussed in relation to some of the figures herein, a predictive and visual cancer map generated by a topological data exploration and visualization platform may assist physicians to determine treatment options.

Those skilled in the art will appreciate that systems and methods described herein may be utilized to perform data exploration and assist in the determination of treatment options for many different kinds of medical conditions including, for example diseases, disorders, or the like. Further, assessed data is not limited to gene expression. Data may come from any one or a number of sources. For example, data may be received from sensors of smartphones, cellphones or wearable technology by any number of users or patients.

In one example, Parkinson's Disease may be detected utilizing information obtained by sensors of a mobile device. Parkinson's Disease (PD) is a degenerative disorder of the central nervous system. Initially it starts as a neurological syndrome characterized by tremor, rigidity, slowness of movement and difficulty with walking Progression of the disease is demonstrated through cognitive impairment affecting sensory problems, sleep and emotional behavior. In the advanced stages it is very common for patients to exhibit signs of dementia. Pathologically, PD is caused by deteriorating dopamine receptors accompanied by accumulation of alpha-synyclein proteins into structures called Lewy bodies. The deterioration of neurons then affects muscle function which is then used for diagnosis.

Diagnosis of Parkinson's Disease is based on subjective assessment of medical history and neurological examination of motoric symptoms. Neuroimaging is utilized to rule out disorders that show similar symptoms to Parkinson's Disease, but there is no known biomarker for PD diagnosis.

The Michael J. Fox Foundation (MJJF) developed a basic smartphone application to collect data from a group of Parkinson's patients and control subjects with the idea of finding out to what extent, if any, this data can be used to measure the symptoms and disease progression of Parkinson's Disease. MJJF collected raw data streams from 9 PD patients and 6 healthy controls roughly matched for age and gender. Each subject carried on their person a supplied Android smartphone over a period from December 2011-March 2012 for at least 4-6 hours a day. The data contained audio, accelometry, compass, ambient, proximity, battery level and GPS streams collected at most once per second. This raw data was deposited on the Kaggle web site (www.kaggle.com) and opened from February 5 to Mar. 27, 2013 to general public in a data mining contest.

Although the Michael J. Fox Foundation captured data utilizing cellphone sensors, the Foundation has been unable to analyze or assess the captured data. By providing the information to the public, the Foundation was requesting for assistance to interpret and/or analyze the data.

In various embodiments, a medical outcome map (e.g., a medical condition map) may be generated based on large amounts of available information generated by researchers and/or sensors. Smartphones, cellphones, and/or wearable technology (e.g., fitness trackers, smartglasses, armbands, chestbands, headbands, legbands, smartrings, smartwatches, and the like) may utilize any number of sensors (e.g., accelerometry, audio, compass, ambient light, proximity, GPS or the like) to generate and upload sensor data. The sensor data may be provided to an analysis system to generate a medical condition map as discussed herein. The information of the medical condition map may be associated with conditions and/or outcomes of patients (e.g., condition detection, development, progression, remission, severity, recovery, ability, disability, and/or death).

A user may utilize smartphones, cellphones, and/or wearable technology to collect sensor data regarding the user. The user's sensor data may be utilized to localize the user's sensor data within the medical condition map. A physician, assistant, or other individual may view the location of the user's sensor data in a visualization of the medical condition map and/or view a summary regarding the user's sensor data location to assist in treatment. New sensor data from the user may continue to add accuracy or indicate changes to the user's condition over time.

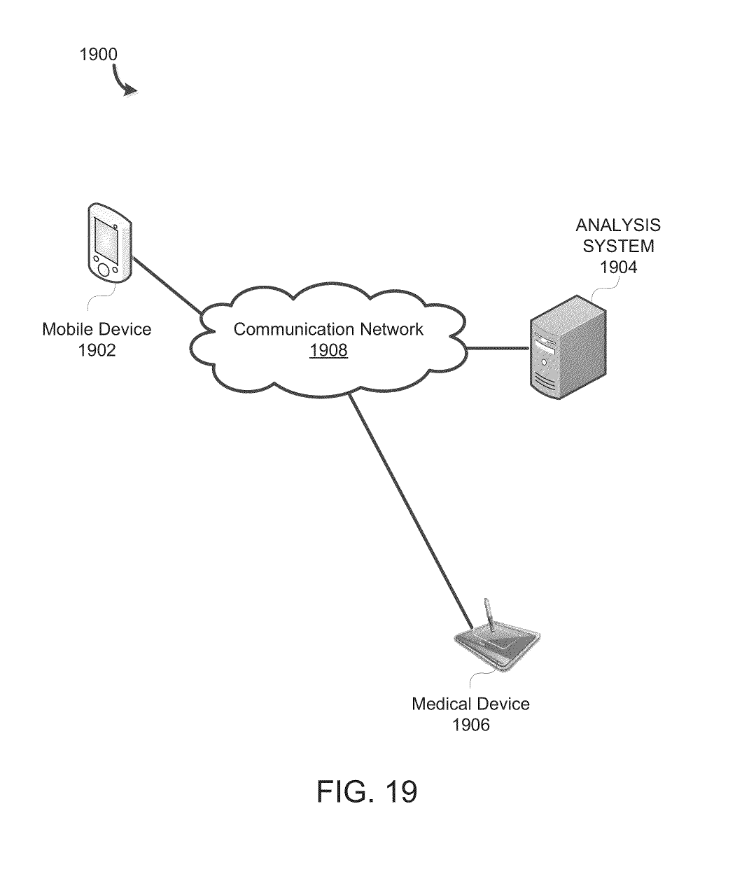

FIG. 19 depicts an environment 1900 in which embodiments may be practiced. Environment 1900 comprises a mobile device 1902, an analysis system 1904, and a medical device 1906 communicating over a communication network 1908. The mobile device 1902, the analysis system 1904, and the medical device 1906 may be digital devices. There may be any number of mobile devices 1902, analysis systems 1904, and medical devices 1906.

The mobile device 1902 may be any mobile device including a cellphone, smartphone, glasses, media device, watch, laptop or wearable technology (e.g., which may include a cellphone, smartphone, bracelet, necklace, glasses, fitness tracker, rings, headband, armband, legband, footwear, or the like). In one example, the mobile device 1902 is a cellphone or smartphone. Cellphones and smartphones have become essential communication devices whose roles have evolved to primary tools for navigation, commerce, and entertainment. In addition, most modern cellphones and smartphones carry basic sensors that can objectively measure physical quantities such, for example, geolocation (GPS coordinates), acceleration, orientation relative to the Earth magnetic field, ambient light, and proximity to other objects.

In various embodiments, a patient may carry a smartphone (and/or any other mobile device 1902) that utilizes one or more different sensors (e.g., acceleration to measure shaking and audio to measure slurring) to collect data of the patient. The information may be utilized to detect and/or map the patient's condition. In one example, utilizing the information, the patient's data may be utilized to create a map that depicts the status and/or changes of the patient's condition relative to other patients (e.g., by the analysis system 1904). As a result, changes in the patient's condition caused by changes in disease progression, treatments, medications, and/or events in the day may be monitored and tracked. The information may be utilized by the patient and/or a medical professional (e.g., via the medical device 1906) to get feedback (e.g., in order to track results related to treatments, medications, exercise, and/or lifestyle choices).

In various embodiments, a user may carry any number of mobile devices, each of which include sensors capable of receiving sensor data (e.g., data generated and/or measured by a sensor). The mobile device 1902 may continuously generate sensor data (e.g., accelerometry data), periodically generate sensor data, or may generate sensor data under certain conditions (e.g., audio data when the user makes a telephone call with the cellphone or smartphone).

The mobile device 1902 may provide any amount of sensor data to the analysis system 1904 at any time. In some embodiments, the mobile device 1902 uploads sensor data when there is a sufficient network connection available (e.g., storing all or some of the sensor data until a network connection of sufficient bandwidth is available). For example, the mobile device 1902 may upload any amount of sensor data when a WiFi network is accessible by the mobile device 1902. The mobile device 1902 may, in some embodiments, provide sensor data at predetermined intervals and/or when a quantity of sensor data is obtained. In some embodiments, the mobile device 1902 may perform an assessment and/or analysis on all or some of the sensor data and provide the sensor data to the analysis system 1904 for any number of reasons (e.g., a significant change in the sensor data).

The analysis system 1904, like the analysis server 108, may include or be a digital device configured to analyze data (e.g., sensor data from any number of patients). In various embodiments, the analysis system 1904 may perform many functions to interpret, examine, analyze, and/or display data and relationships within sensor data. In some embodiments, the analysis system 1904 performs a topological analysis of large datasets applying metrics, filters, and resolution parameters chosen by the user. In various embodiments, the analysis system 1904 performs a non-topological analysis. Those skilled in the art will appreciate that the analysis system 1904 may perform the topological analysis, the non-topological analysis, or both.

The analysis system 1904 may generate a medical condition map of the output of the analysis. In some embodiments, the medical condition map is not rendered or displayed. The medical condition map may assist in the discovery or suggestion of relationships in data. In some embodiments, the medical condition map is an interactive visualization that allows the user to select nodes comprising data that has been clustered. The user may then access the underlying data, perform further analysis (e.g., statistical analysis) on the underlying data, and manually reorient the graph(s) (e.g., structures of nodes and edges described herein) within the interactive visualization. The medical condition map may also allow for the user to interact with the data and see the graphic result.

In some embodiments, the analysis system 1904 interacts with the mobile device 1902 and/or the medical device 1906 (e.g., via the communication network 1908). The mobile device 1902 may comprise a client program that allows the mobile device 1902 to upload or otherwise provide sensor data to the analysis system 1904. The analysis system 1904 may include the analysis server 108.

Those skilled in the art will appreciate that all or part of the data analysis may occur at the mobile device 1902, the analysis system 1904, and/or the medical device 1906. Further, those skilled in the art will appreciate that cloud computing utilizing the analysis system 1904 may allow for greater access to large datasets (e.g., via a commercial storage service) over a faster connection. Further, services and computing resources offered to the user(s) may be scalable.

The medical device 1906 is any digital device. The medical device 1906 may be configured to depict a visualization and/or a summary of the medical condition map. In some embodiments, the medical device 1906 depicts a visualization and/or summary regarding a user's or patient's relationship (i.e., location or position) relative to the medical condition map (e.g., the medical condition map may include data and/or outcomes related to sensor data of any number of other patients). The user's or patient's relationship may be based on sensor data from the mobile device 1902 assessed and/or analyzed by the analysis system 1904.

Those skilled in the art will appreciate that the medical device 1906 may be a tablet, computer, laptop, smartphone, wearable technology, or the like that may display information to a medical professional such as a technician, physician, assistant or the like to assist in treatment. In various embodiments, the medical device 1906 may generate alerts regarding the user or patient based on at least some of the sensor data from the mobile device 1902.

The communication network 1908 may include a computer network or combination of user networks (e.g., a combination of wireless and wired networks). The communication network 1908 may include technologies such as Ethernet, 802.11x, worldwide interoperability for microwave access WiMAX, 2G, 3G, 4G, CDMA, GSM, LTE, digital subscriber line (DSL), and/or the like. The communication network 1908 may further include networking protocols such as multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and/or the like. The data exchanged over the communication network 1908 can be represented using technologies and/or formats including hypertext markup language (HTML) and extensible markup language (XML).

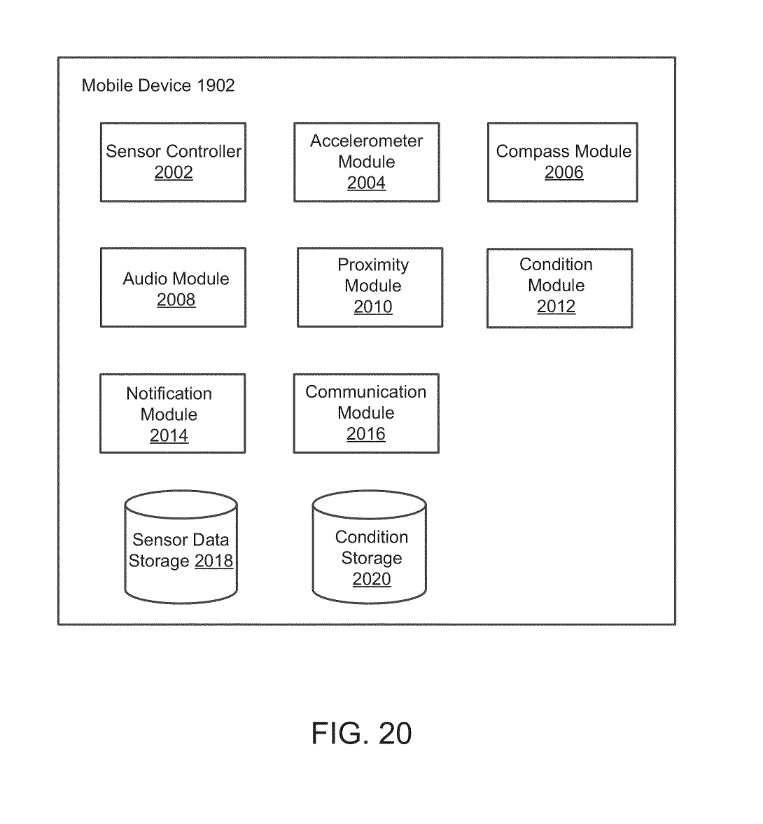

FIG. 20 is a block diagram of the mobile device 1902 in some embodiments. The mobile device 1902 may comprise a sensor controller 2002, an accelerometer module 2004, a compass module 2006, an audio module 2008, a proximity module 2010, a condition module 2012, a notification module 2014, a communication module 2016, a sensor data storage 2018, and a condition storage 2020. In various embodiments, the sensor controller 2002 controls any number of sensors of the mobile device 1902 (e.g., the sensor controller 2002 may control the accelerometer module 2004, the compass module 2006, the audio module 2008, and the proximity module 2010).

The sensor controller 2002 may be configured by an agent on the mobile device 1902. The sensor controller 2002 may receive instructions based on a condition. For example, the sensor controller 2002 may be configured to provide sensor data from any number of sensors based on a condition. The condition may be configured by the user of the mobile device 1902 (e.g., through the agent) or provided by the analysis system 1904, the medical device 1906, or another digital device. The condition may indicate the type of sensor data to collect, when to collect the sensor data, and/or when to provide the collected sensor data.

In one example, the condition may include instructions to collect sensor data from the accelerometer module 2004 and the compass module 2006 but not the audio module 2008 or the proximity module 2010. Any number of conditions may include instructions to collect any type of sensor data from any number of sensors.

The condition may include instructions as to when to collect data. For example, the condition may include instructions to collect data from the accelerometer when sensor data from the accelerometer exceed one or more thresholds. In another example, the condition may include instructions to collect data form the compass module 2006 if orientation of the mobile device 1902 has changed or has been changing over a predetermined number of times during a predetermined time period.

The condition may also include instructions regarding when to provide the collected sensor data. In some embodiments, the condition may include instructions to provide collected data when a network of sufficient capability is detected (e.g., the sensor controller 2002 may be configured to provide collected sensor data when LTE or WiFi connectivity is detected but not 3G connectivity). In some embodiments, the condition may include instructions to upload sensor data continuously (e.g., when connectivity is available) or may upload sensor data periodically (e.g., on a predetermined period of time, in or after predetermined intervals, and/or depending on an amount of sensor data collected).

The accelerometer module 2004, the compass module 2006, the audio module 2008, and the proximity module 2010 may each control related sensors and may each receive related sensor data. There may be any number of sensors and/or sensor modules. The accelerometer module 2004 may control and/or receive accelerometer values. The compass module 2006 may control and/or receive compass values (e.g., orientation values). The audio module 2008 may control and/or receive ambient sounds or voice information from the user of the mobile device 1902 during calls and/or when there is not a call. The proximity sensor 2010 control and/or receive proximity values related to proximity of the mobile device 1902 to the user (e.g., the user's face). The accelerometer module 2004, the compass module 2006, the audio module 2008, and the proximity module 2010 may provide sensor data to the sensor data storage 2018.

Any or all of the sensor modules (the accelerometer module 2004, the compass module 2006, the audio module 2008, and the proximity module 2010) may be controlled by the sensor controller 2002. The sensor controller 2002 may receive instructions related to one or more conditions from the condition storage 2020.

The condition module 2012 may be configured to receive conditions from the user, the analysis system 1904, the medical device 1906, and/or another digital device. Any number of conditions may be configured. The condition module 2012 may store conditions to and/or receive conditions from the condition storage 2020. In some embodiments, the condition module 2012 provides conditions to and/or instructs the sensor controller 2002 based on one or more conditions.

The notification module 2014 may be configured to provide notifications to the user. In some embodiments, the notification module 2014 may encourage the user to activate or deactivate one or more sensors based on conditions from the condition module 2012. In some embodiments, the notification module 2014 may provide notifications to the user of the mobile device 1902 based on the collected sensor data (e.g., when the sensor data is unexpected). The notification module 2014 may, in some embodiments, provide notifications to the user based on messages received from the analysis system 1904 described herein and/or the medical device 1906.

The communication module 2016 may be any communication interface that enables communication between the mobile device 1902 and other digital devices. In one example, the communication module 2016 enables communication between the mobile device 1902 and the analysis system 1904 via the communication network 1908.

In various embodiments, the communication module 2016 may provide user information (e.g., a username or other user identifier), sensor type identifiers (e.g., identifying the type of sensor data to be provided), timestamps associated with sensor data (e.g., when the sensor data was collected), agent version information (e.g., identifying a software version of the agent), condition identifier(s) (e.g., identifying the conditions that provide instructions to the sensor controller 2002), and/or the like.

The sensor data storage 2018 and the condition storage 2020 may comprise any number and any type of storage devices and/or data structures.

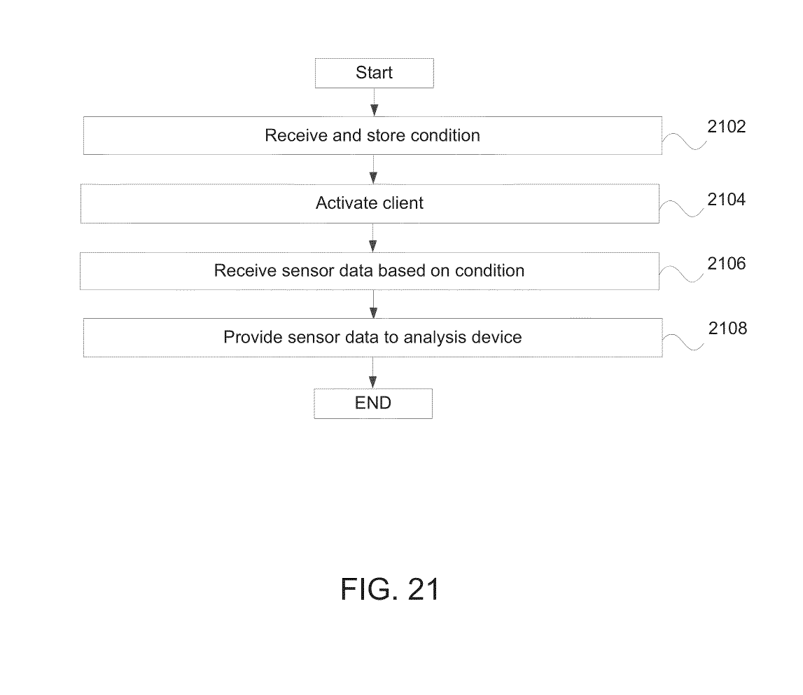

FIG. 21 is a flowchart for collecting sensor data by the mobile device 1902 in some embodiments. In step 2102, the condition module 2012 receives and stores conditions (e.g., the conditions may be provided by the analysis system 1904 and/or the medical device 1906).

In step 2104, the user or the mobile device 1902 may activate the agent configured to collect sensor data. In step 2106, sensor modules (the accelerometer module 2004, the compass module 2006, the audio module 2008, the proximity module 2010, and/or other sensor modules) may collect sensor data from any number of sensors based on condition instructions.

In step 2108, the communication module 2016 may provide the sensor data to the analysis system 1904.

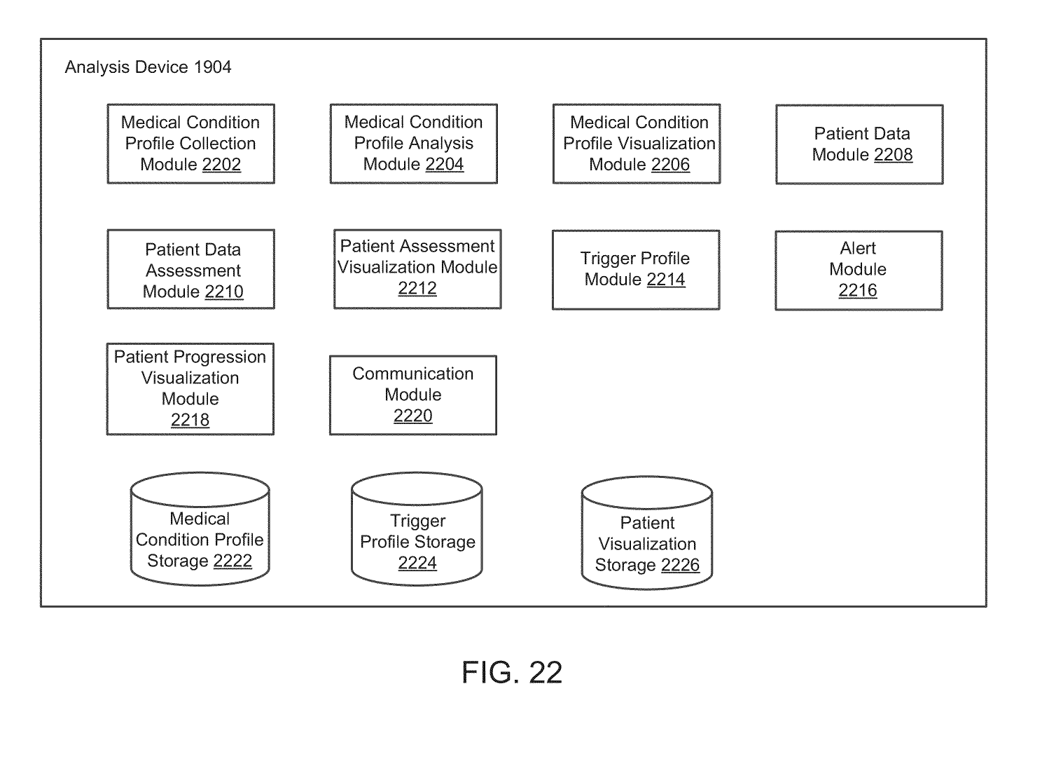

FIG. 22 is a block diagram of an analysis device 1904 in some embodiments. The analysis device 1904 may comprise a medical condition profile collection module 2202, a medical condition profile analysis module 2204, a medical condition profile visualization module 2206, a patient data module 2208, a patient data assessment module 2210, a patient assessment visualization module 2212, a trigger profile module 2214, an alert module 2216, a patient progression visualization module 2218, a communication module 2220, a medical condition profile storage 2222, a trigger profile storage 2224, and a patient visualization storage 2226.

The medical condition profile collection module 2202 may receive sensor data for any number of patients. The sensor data may be collected from sensors of one or more mobile devices associated with each patient. The sensor data may include, for example, accelerometry data, compass data, audio data, proximity data, temperature data, image data, and/or the like.

In various embodiments, the medical condition profile collection module 2202 may collect different sensor data for different medical conditions. For example, the medical condition profile collection module 2202 may identify a medical condition profile (e.g., PD or cancer). The mobile device(s) associated with different patients may be configured to provide a subset of sensor data to the medical condition profile collection module 2202 based on the medical condition profile (e.g., based on a condition associated with the medical condition profile). In some embodiments, the mobile device(s) may provide any amount of sensor data and the medical condition profile collection module 2202 may collect and store a subset of the amount of sensor data received (e.g., the collected and stored subset of sensor data may be related to the medical condition profile).

In various embodiments, although the medical condition profile collection module 2202 may receive sensor data from any number of patients, the medical condition profile collection module 2202 may collect and store sensor data based on the patient and the medical condition profile(s). For example, one patient may have PD or a combination of medical conditions. The medical condition profile collection module 2202 may be configured to identify the patient based on information associated with the sensor data (e.g., a patient identifier) and store all or some of the sensor data in the medical condition profile(s) associated with the patient.

The medical condition profile collection module 2202 may store received and/or collected sensor data associated with the patients and the medical condition profile in the medical condition profile storage 2224.

The medical condition profile analysis module 2204 may be configured to assess and/or analyze any or all of the sensor data associated with a medical condition profile. The medical condition profile analysis module 2204 may analyze and/or asses the data in any number of ways including the utilization of topological data analysis or non-topological data analysis. In one example, the medical condition profile analysis module 2204 may perform a method similar to that in FIG. 12. For example, in step 1202, the medical condition profile analysis module 2204 may receive sensor data and clinical outcome(s) of previous patients. The medical condition profile analysis module 2204 may receive a density filter selection and perform a density function on the sensor data of previous patients to map sensor data into a reference space in steps 1204 and 1206. The medical condition profile analysis module 2204 may receive a resolution selection and generate a cover using the selected resolution in steps 1208 and 1210. The resulting information may indicate shared biological similarities.

In some embodiments, the medical condition profile analysis module 2204 may cluster mapped sensor data. The visualization may or may not be rendered. Although the discussion regarding FIG. 12 is directed to biological data and includes steps for generating a visualization map and displaying attributes, those skilled in the art will appreciate that the discussion regarding FIG. 12 can be directed to sensor data as described herein.

In some embodiments, the medical condition profile analysis module 2204 may assess sensor data from any number of patients using non-topological data analysis (TDA). Those skilled in the art will appreciate that any analysis, including non-TDA analysis may be applied. In some embodiment, the medical condition map could be built from any graph construction algorithm such as a hierarchical clustering tree built off of sensor data. For example, sensor data together with a distance metric can be used to build a hierarchical tree of patients. New patent sensor data could use the same distance metric against all the patients used to build the hierarchical tree to determine the existence of a trigger event.

Further, the notion of a patient graph can be generalized additionally as follows: suppose each vertex represents an individual patient, with an edge connecting all patients. For each pair of vertices g_i, g_j, there exists an edge e_{i,j}, with weight w_{i,j} which corresponds to the similarity of patients g_i, and g_j; remove all edges e whose weight w<q. The result is a graph whose remaining reified edges are between notionally similar patients. The methods described prior can be applied to any graph representation.

The medical condition profile visualization module 2206 may be configured to render and/or display a visualization of the medical condition map as disclosed herein (e.g., in a manner similar to the discussion regarding FIG. 12 or a non-TDA medical condition map). In some embodiments, the medical condition profile visualization module 2206 may render and store the medical condition profile visualization module 2206 within the patient visualization storage 2226. For example, the exemplary visualization of FIG. 14 may be a medical condition map.

The patient data module 2208 may receive sensor data for one or more users (e.g., one or more users of one or more mobile devices 1902). The sensor data may be collected from sensors of one or more mobile devices associated with a user. As similarly discussed regarding the medical condition profile collection module 2202, the sensor data may include, for example, accelerometry data, compass data, audio data, proximity data, temperature data, image data, and/or the like.

In various embodiments, the patient data module 2208 may collect different sensor data for different medical conditions (e.g., based on one or more conditions). For example, the patient data module 2208 may identify a medical condition profile. The mobile device(s) associated with a user may be configured to provide a subset of sensor data to the patient data module 2208 based on the medical condition profile. In some embodiments, the mobile device(s) may provide any amount of sensor data and the patient data module 2208 may collect and store a subset of the amount of sensor data received (e.g., the collected and stored subset of sensor data may be related to the medical condition profile). In some embodiments, the patient data module 2208 provides the conditions to the mobile device 1902.

In various embodiments, the patient data module 2208 may collect and store sensor data based on the user and the medical condition profile. For example, one user may have a variety of different medical conditions. The patient data module 2208 may be configured to identify the user based on information associated with the sensor data (e.g., a user identifier) and store all or some of the sensor data in one or more medical condition profiles associated with the user.

The patient data module 2208 may store received and/or collected sensor data associated with the user and the medical condition profile in the medical condition profile storage 2222.

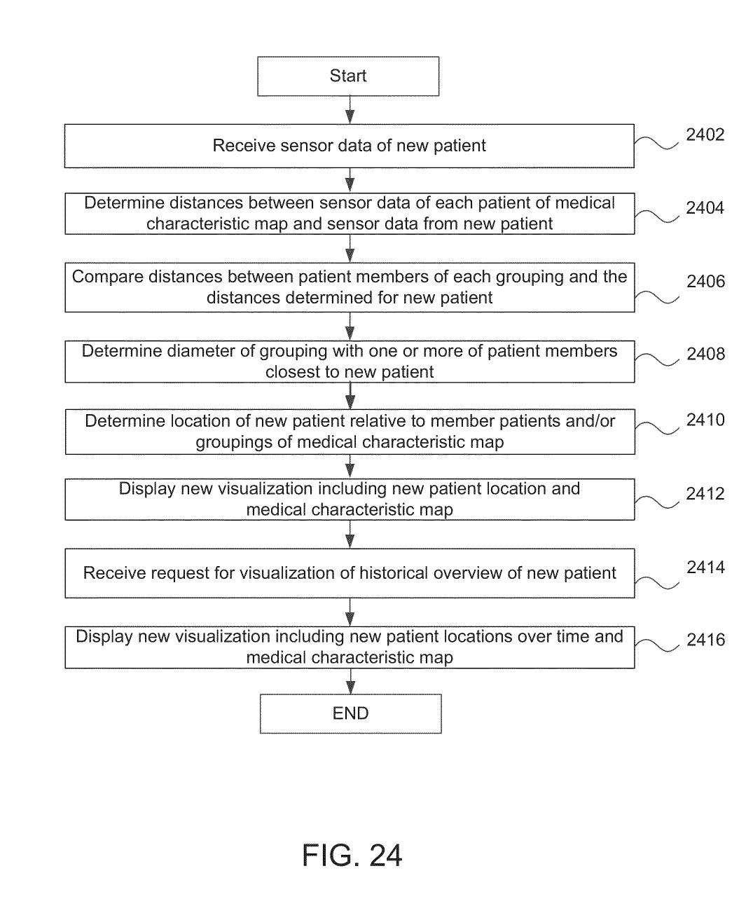

The patient data assessment module 2210 may be configured to assess and/or analyze all or some sensor data associated with a medical condition profile. In some embodiments, the sensor data received by the patient data module 2208 may be assessed in the context of a medical condition map based on sensor data of a plurality of patients (e.g., the map being generated by the medical condition profile analysis module 2204). An exemplary process of assessment and/or analysis of sensor data from a user is discussed with regard to FIG. 24. Those skilled in the art will appreciate that the sensor data may be assessed and/or analyzed in the context of the medical condition map in any number of ways (e.g., utilizing TDA and/or non-TDA tools and techniques).

The trigger profile module 2214 may retrieve one or more triggers associated with a condition classification. Each trigger may define trigger conditions. A condition classification may be related to one or more medical conditions (e.g., PD). Condition classifications may include, but are not limited to:

Condition detection

Condition development

Condition progression

Treatment efficacy

Condition Control

A condition detection classification may be a category of patients and/or users that have not yet been diagnosed with a medical condition, such as a disease. In one example, trigger conditions associated with the condition detection classification may be satisfied when sensor data suggests or indicates the patient or user may have a disease or are in preliminary stages.

A condition development classification may be a category of patients and/or users who may have the initial stages of a developing medical condition. In one example, trigger conditions associated with the condition development classification may be satisfied when sensor data suggests or indicates that a condition the patient or user may have is developing (e.g., worsening or improving).

A condition progression classification may be a category of patients and/or users who may have been diagnosed as having a medical condition and the condition may be progressing. In one example, trigger conditions associated with the condition progression classification may be satisfied when sensor data suggests or indicates that a condition the patient or user may have is progresses (e.g., significant changes are detected and/or condition markers are indicated in the sensor data).

A treatment efficacy classification may be a category of patients and/or users who may have received treatment such as pharmaceuticals, procedures, and the like. In one example, trigger conditions associated with the treatment efficacy classification may be satisfied when sensor data suggests or indicates that side effects, desired effects, or ineffectiveness of treatment of the patient or user.

A condition control classification may be a category of patients and/or users who may have a medical condition that is in remission or that is being controlled. In one example, trigger conditions associated with the condition control classification may be satisfied when sensor data suggests or indicates that a condition is no longer in remission or acting as expected.

Those skilled in the art will appreciate that there may be any number of condition classifications associated with different trigger profiles. A user or patient may be associated with any number of trigger profiles related to any number of conditions. For example, the trigger profile module 2214 may retrieve trigger profiles for the user or patient that includes condition detection classification trigger profiles for any number of diseases or conditions that user or patient is not expected or known to have. In some embodiments, the trigger profile module 2214 may retrieve additional trigger profiles associated with one or more known conditions that the user or patient has (e.g., condition progression classification trigger profiles for PD and condition treatment efficacy trigger profiles for PD).

The trigger profile module 2214 may store the trigger profiles in the trigger profile storage 2224.

The alert module 2216 may monitor sensor data and/or analysis of sensor data to determine when trigger condition(s) are satisfied based on the sensor data received from the user or patient, based on an assessment or analysis of the sensor data received from the user or patient, and/or based on a comparison of the sensor data from the user or patient with a medical characterization map.

The alert module 2216 may provide any number of notifications or alerts including sounds, images, email, texts (e.g., SMS), phone calls, or the like. The alert module 2216 may provide the alerts to medical personnel, a user of the medical device 1906, or any other individual(s) or digital device(s).

The patient progression visualization module 2218 may track historical information regarding the patient or user and generate a visualization indicating the relative locations associated with the patient or user with regard to a medical condition map. The patient progression visualization module 2218 may also be configured to generate labels or annotations to identify the various locations (e.g., to identify when the sensor data was collected or the like) with regard to the medical condition map.

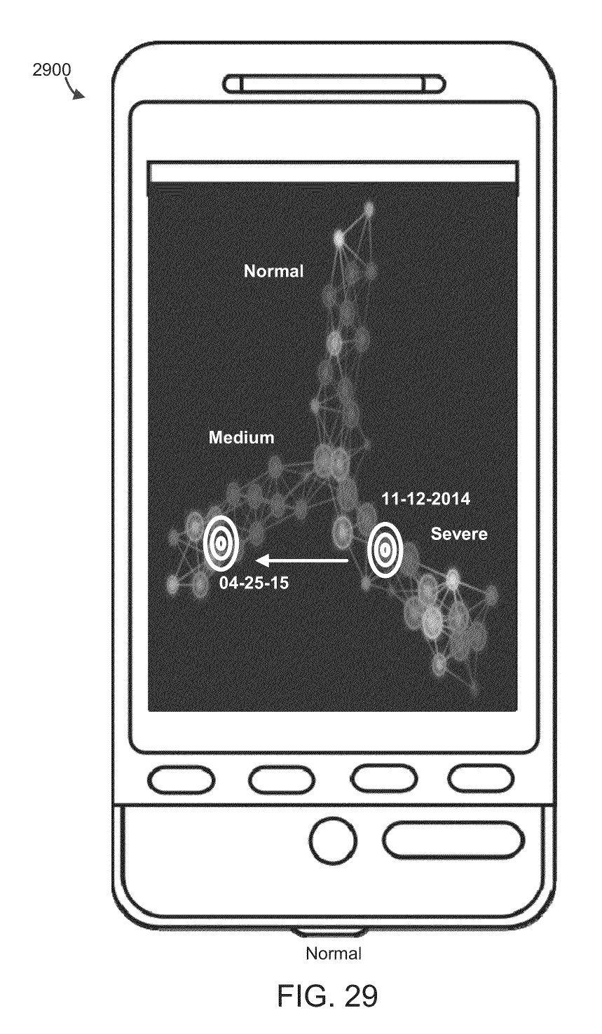

For example, the patient progression visualization module 2218 may be configured to associated sensor data with a timestamp or other identifier which may indicate when sensor data was received, assessed, or the like. In some embodiments, the patient progression visualization module 2218 may be configured to associated sensor data with an identifier indicating when the visualization including one or more relative locations associated with the patient or user was provided or summarized to the user of the medical device 1906 (e.g., physician, assistant, or the like). Those skilled in the art will appreciate that the labels or annotations may provide or be configured to provide any kind of information. An example of patient progression is depicted in FIG. 29.

In various embodiments, the patient progression visualization module 2218 may control the amount of data to be displayed including a number of positions of the user or patient (e.g., based on time frame, type of sensor data, or the like). In various embodiments, the visualization of the medical condition map may be automated to depict the different positions or locations of the user or patient over time (e.g., based on chronology of sensor data received). Those skilled in the art will appreciate that any or all of the positions may be depicted in any order.

The communication module 2220 may be configured to provide communication between the analysis device 1904 and any other device. For example, the medical condition profile collection module 2202 may receive sensor data over the communication module 2220. The medical condition profile visualization module 2206 and/or the patient assessment visualization module 2212 may provide visualizations to another digital device (e.g., medical device 1906) via the communication module 2220. The alert module 2216 may receive or provide alerts or notifications over the communication module 2220. Similarly the trigger profile module 2214 may receive and/or provide triggers and/or trigger profiles over the communication module 2220. In some embodiments, the communication module 2220 is communicatively coupled with the communication network 1908.

The medical condition profile storage 2222, the trigger profile storage 2224, and the patient visualization storage 2226 may comprise any number and any type of storage devices and/or data structures.

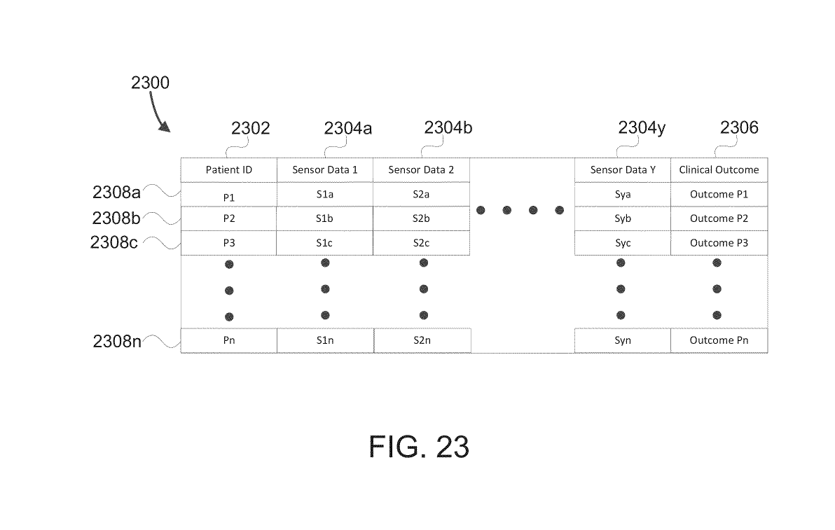

FIG. 23 is an exemplary data structure 2302 including sensor data 2304a-2304y for a number of patients 2308a-2308n that may be used to generate the map in some embodiments. In various embodiments, the map may be generated in memory and may not be a viewable map (e.g., the map may not be rendered to enable display). Column 2302 represents different patient identifiers for different patients. The patient identifiers may be any identifier.

At least some sensor data may be contained within sensor measurements 2304a-2304y. In FIG. 23, “y” represents any number. For example, there may be 50,000 or more separate columns for different sensor data related to a single patient or related to one or more samples from a patient. Those skilled in the art will appreciate that column 2304a may represent a sensor data measurement for each patient (if any for some patients) associated with the patient identifiers in column 2302. The column 2304b may represent a sensor data measurement of one or more sensors that are different than that of column 2304a. As discussed, there may be any number of columns representing different sensor data measurements.

Column 2306 may include any number of clinical outcomes, prognoses, diagnoses, reactions, treatments, and/or any other information associated with each patient. All or some of the information contained in column 2306 may be displayed (e.g., by a label or an annotation that is displayed on the visualization) on or for the medical condition map or summary.

Rows 2308a-2308n each contains biological data associated with the patient identifier of the row. For example, sensor data in row 2308a are associated with patient identifier P1. As similarly discussed with regard to “y” herein, “n” represents any number. For example, there may be 100,000 or more separate rows for different patients.

Those skilled in the art will appreciate that there may be any number of data structures that contain any amount of sensor data for any number of patients. The data structure(s) may be utilized to generate any number of medical condition maps.

In various embodiments, the analysis system 1904 may receive a filter selection. In some embodiments, the filter selection is a density estimation function. Those skilled in the art will appreciate that the filter selection may include a selection of one or more functions to generate a reference space.

The analysis system 1904 may perform the selected filter(s) on the sensor data of the previous patients to map the sensor data into a reference space. In one example, a density estimation function, which is well known in the art, may be performed on the sensor data (e.g., data associated with sensor data measurements 2304a-2304y) to relate each patient identifier to one or more locations in the reference space (e.g., on a real line).

The analysis system 1904 may receive a resolution selection. The resolution may be utilized to identify overlapping portions of the reference space (e.g., a cover of the reference space R).

As discussed herein, the cover of R may be a finite collection of open sets (in the metric of R) such that every point in R lies in at least one of these sets. In various examples, R is k-dimensional Euclidean space, where k is the number of filter functions. Those skilled in the art will appreciate that the cover of the reference space R may be controlled by the number of intervals and the overlap identified in the resolution (e.g., see FIG. 7). For example, the more intervals, the finer the resolution in S (e.g., the similarity space of the received sensor data)—that is, the fewer points in each S(d), but the more similar (with respect to the filters) these points may be. The greater the overlap, the more times that clusters in S(d) may intersect clusters in S(e)—this means that more “relationships” between points may appear, but, in some embodiments, the greater the overlap, the more likely that accidental relationships may appear.

The analysis system 1904 may receive a metric to cluster the information of the cover in the reference space to partition S(d). In one example, the metric may be a Pearson Correlation. The clusters may form the groupings (e.g., nodes or balls). Various cluster means may be used including, but not limited to, a single linkage, average linkage, complete linkage, or k-means method.

As discussed herein, in some embodiments, the analysis module 1904 may not cluster two points unless filter values are sufficiently “related” (recall that while normally related may mean “close,” the cover may impose a much more general relationship on the filter values, such as relating two points s and t if ref(s) and ref(t) are sufficiently close to the same circle in the plane where ref( ) represents one or more filter functions). The output may be a simplicial complex, from which one can extract its 1-skeleton. The nodes of the complex may be partial clusters, (i.e., clusters constructed from subsets of S specified as the preimages of sets in the given covering of the reference space R).

The analysis system 1904 may generate the map with nodes representing clusters of patient members and edges between nodes representing common patient members. In one example, the analysis server identifies nodes which are associated with a subset of the partition elements of all of the S(d) for generating the map.

As discussed herein, for example, suppose that S={1, 2, 3, 4}, and the cover is C₁, C₂, C₃. Suppose cover C₁ contains {1, 4}, C₂ contains {1,2}, and C₃ contains {1,2,3,4}. If 1 and 2 are close enough to be clustered, and 3 and 4 are, but nothing else, then the clustering for S(1) may be {1}, {4}, and for S(2) it may be {1,2}, and for S(3) it may be {1,2}, {3,4}. So the generated graph has, in this example, at most four nodes, given by the sets {1}, {4}, {1, 2}, and {3, 4} (note that {1, 2} appears in two different clusterings). Of the sets of points that are used, two nodes intersect provided that the associated node sets have a non-empty intersection (although this could easily be modified to allow users to require that the intersection is “large enough” either in absolute or relative terms).

As a result of clustering, member patients of a grouping may share biological similarities (e.g., similarities based on the sensor data).

The analysis server may join clusters to identify edges (e.g., connecting lines between nodes). Clusters joined by edges (i.e., interconnections) share one or more member patients. In some embodiments, the map (e.g., medical condition map) may not be rendered and, as a result, the map may not be displayed. In various embodiments, the map may be rendered and a display may display the map with attributes based on the clinical outcomes contained in the data structures (e.g., see FIG. 23 regarding clinical outcomes). Any labels or annotations may be utilized based on information contained in the data structures. For example, treatments, prognoses, therapies, diagnoses, and the like may be used to label the map. In some embodiments, the physician or other user of the map accesses the annotations or labels by interacting with the map.

FIG. 24 is a flowchart of for positioning new patient sensor data relative to a medical condition map in some embodiments. In step 2402, new sensor data of a new patient is received. In various embodiments, a patient data module 2208 of an analysis system (e.g., analysis system 1904 of FIGS. 19 and 22) may receive sensor data of a new patient from a patient's (or user's) mobile device. The sensor data may comprise any sensor measurements from any number of sensors on the mobile device. In various embodiments, sensor data may comprise multiple measurements of one or more sensors over time. Those skilled in the art will appreciate that the patient data module 2208 may receive sensor data in real time.

In step 2404, the patient data assessment module 2210 determines distances between the sensor data of each patient of a medical condition map and the sensor data from the new patient's mobile device. For example, the sensor data of each patient of the medical condition map may be stored in mapped data structures. Distances may be determined between the new sensor data of the new patient and each of the previous patient's sensor data in the mapped data structure. In various embodiments, distances may be determined between the new sensor data of the new patient and a subset of the previous patient's sensor data in the mapped data structure.

Those skilled in the art will appreciate that distances may be determined in any number of ways using any number of different metrics or functions. Distances may be determined between the sensor data of the previous patients and the new patients. For example, a distance may be determined between a first sensor data measurement of the new patient and each (or a subset) of the first sensor measurements of the previous patients (e.g., the distance between S1 of the new patient and S1 of each previous patient may be calculated). Distances may be determined between all (or a subset of) other sensor data measurements of the new patient to the sensor data measurements of the previous patients.

In step 2406, the patient data assessment module 2210 may compare distances between the patient members of each grouping to the distances determined for the new patient. The new patient may be located in the grouping of patient members that are closest in distance to the new patient. In some embodiments, the new patient location may be determined to be within a grouping that contains the one or more patient members that are closest to the new patient (even if other members of the grouping have longer distances with the new patient). In some embodiments, this step is optional.

In some embodiments, distances may be compared between a subset of patient members of each grouping to the distances determined for the new patient. In various embodiments, distances may be compared between a representative patient member or an aggregate measure of the group to the distances determined for the new patient. For example, a representative patient member may be determined for each grouping. For example, some or all of the patient members of a grouping may be averaged or otherwise combined to generate a representative patient member of the grouping (e.g., the distances and/or sensor data of the patient members may be averaged or aggregated). Distances may be determined between the new patient sensor data and the averaged or combined sensor data of one or more representative patient members of one or more groupings. The patient data assessment module 2210 may determine the location of the new patient based on the distances. In some embodiments, once the closest distance between the new patient and the representative patient member is found, distances may be determined between the new patient and the individual patient members of the grouping associated with the closest representative patient member.

In optional step 2408, a diameter of the grouping with the one or more of the patient members that are closest to the new patient (based on the determined distances) may be determined. In one example, the diameters of the groupings of patient members closest to the new patient are calculated. The diameter of the grouping may be a distance between two patient members who are the farthest from each other when compared to the distances between all patient members of the grouping. If the distance between the new patient and the closest patient member of the grouping is less than the diameter of the grouping, the new patient may be located within the grouping. If the distance between the new patient and the closest patient member of the grouping is greater than the diameter of the grouping, the new patient may be outside the grouping (e.g., a new grouping may be represented in the medical condition map with the new patient as the single patient member of the grouping). If the distance between the new patient and the closest patient member of the grouping is equal to the diameter of the grouping, the new patient may be placed within or outside the grouping.

It will be appreciated that the determination of the diameter of the grouping is not required in determining whether the new patient location is within or outside of a grouping. In various embodiments, a distribution of distances between member patients and between member patients and the new patient is determined. The decision to locate the new patient within or outside of the grouping may be based on the distribution. For example, if there is a gap in the distribution of distances, the new patient may be separated from the grouping (e.g., as a new grouping). In some embodiments, if the gap is greater than a preexisting threshold (e.g., established by the physician, other user, or previously programmed), the new patient may be placed in a new grouping that is placed relative to the grouping of the closest member patients. The process of calculating the distribution of distances of candidate member patients to determine whether there may be two or more groupings may be utilized in generation of the medical condition map. Those skilled in the art will appreciate that there may be any number of ways to determine whether a new patient should be included within a grouping of other patient members.

In step 2410, the patient data assessment module 2210 determines the location of the new patient relative to the member patients and/or groupings of the medical condition map. The new location may be relative to the determined distances between the new patient and the previous patients. The location of the new patient may be part of a previously existing grouping or may form a new grouping.

In some embodiments, the location of the new patient with regard to the medical condition map may be performed locally to the physician. For example, the medical condition map may be provided to the physician (e.g., via medical device 1906). The physician may load the new patient's sensor data locally and the distances may be determined locally or via a cloud-based server. The location(s) associated with the new patient may be overlaid on the previously existing medical condition map either locally or remotely.

Those skilled in the art will appreciate that, in some embodiments, the previous state of the medical condition map may be retained or otherwise stored and a new medical condition map generated utilizing the new patient sensor data. The newly generated map may be compared to the previous state and the differences may be highlighted thereby, in some embodiments, highlighting the location(s) associated with the new patient. In this way, distances may be not be calculated as described with regard to FIG. 24, but rather, the process may be similar to that as previously discussed.

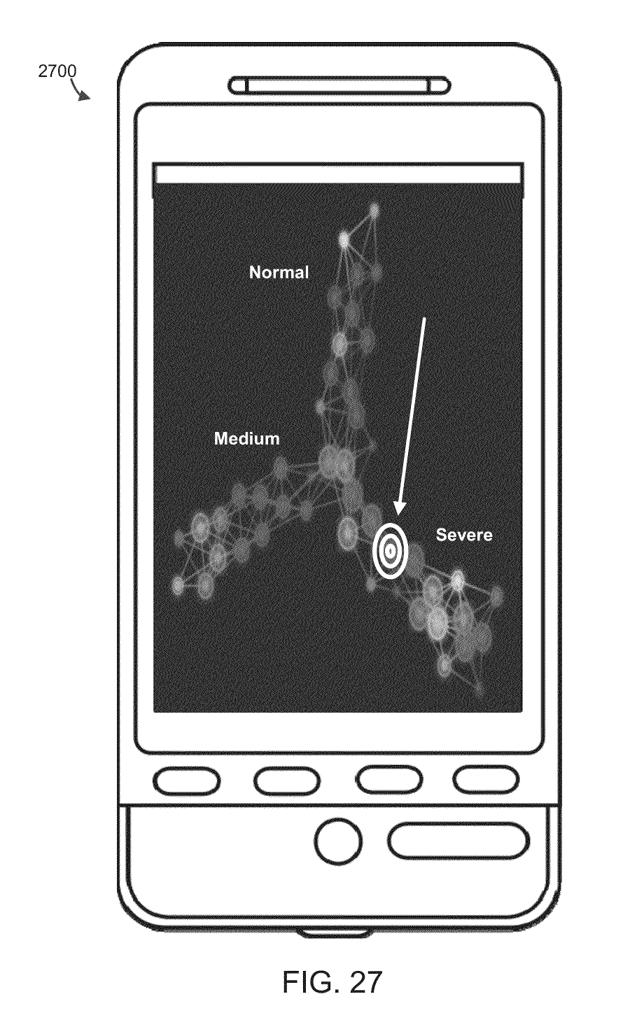

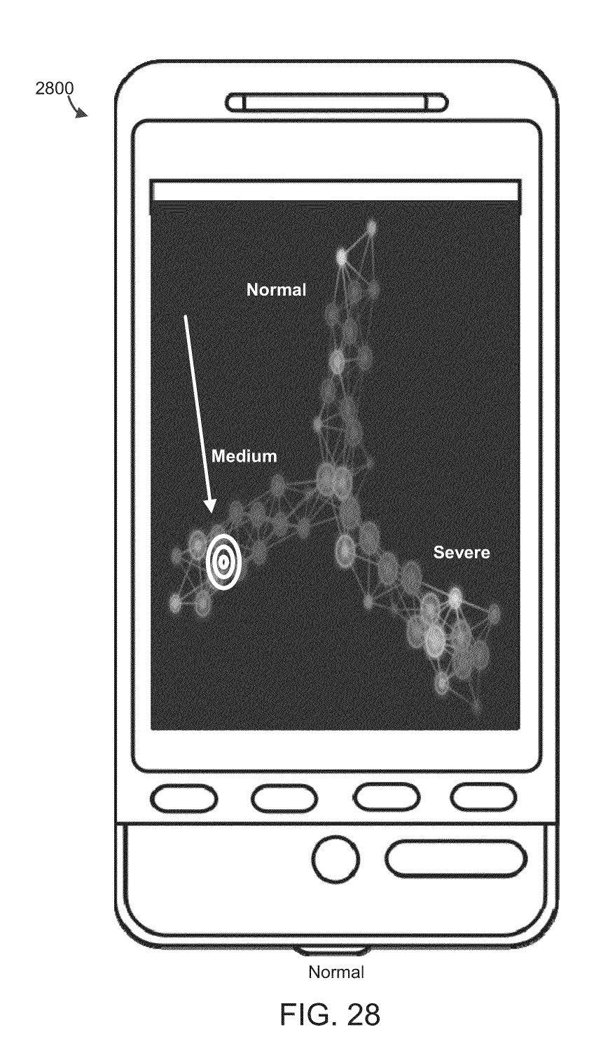

In step 2412, the patient assessment visualization module 2212 may display a new visualization including new patient location and the medical condition map. An example of the visualization of the new patient location and the medical condition map are depicted in FIGS. 27 and 28. In various embodiments, a visualization of the map is not depicted. In some embodiments, a summary associated with the new patient based on current and/or past sensor data may be displayed. The summary may include information associated with medical characteristics, biological data, and/or sensor data of previous patients (e.g., associated with patient members described herein).

In step 2414, the patient progression visualization module 2218 receives a request for a visualization of historical overview of the new patient. The request may be provided by the medical device 1906 (e.g., by a physician, assistant, or medical personnel). The visualization of historical overview may depict past positions of the new patient over time in step 2416. For example, the medical device 1906 may depict a slider or other input that allows the user of the medical device 1906 to input a time frame. The medical device 1906 and/or the analysis system 1904 may render the medical condition map and depict different positions of the user over time (see FIG. 29 for example). The different positions may be annotated (e.g., labeled) to indicate the time frame.

In some embodiments, the different positions are automated to show a progression over time. In some embodiments, the user of the medical device 1906 may input a setting indicated the speed of progression. The medical device 1906 may display the position of the new patient over time to enable the user of the medical device 1906 to inspect progression of the new patient in the visualization.

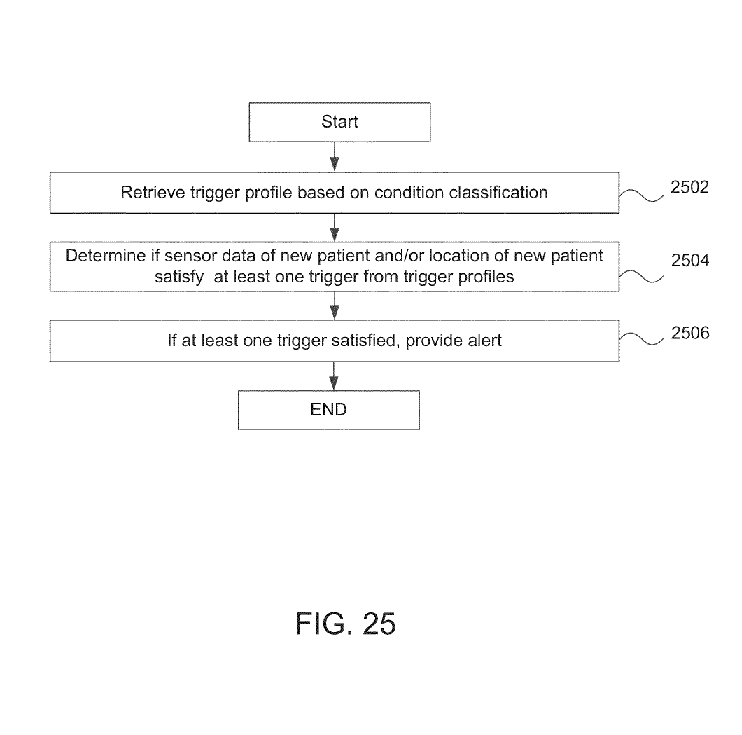

FIG. 25 is a flowchart for providing alerts based on satisfaction of a trigger condition based at least in part on sensor data of the user in some embodiments. In step 2502, the trigger profile module 2214 retrieves a trigger profile based on condition classification. In some embodiments, the condition classification may be provided by the user mobile device 1902 (e.g., with the sensor data) or provided by the analysis device 1904 (e.g., the condition classification may be associated with the patient). In some embodiments, the trigger profile module 2214 retrieves any and/or all profiles associated with the patient.

Those skilled in the art will appreciate that multiple condition classifications may be associated with the patient. As discussed herein, a patient or user may be associated with condition classifications such as condition detection as well as condition development. Another patient or user may be associated with condition classifications as condition development, condition progression, medical treatment effect, and condition control. In these examples, the trigger profile module 2214 may retrieve any number of triggers associated with any number of trigger profile modules 2214.

In step 2504, the alert module 2216 determines if sensor data of new patient and/or location of new patient satisfy at least one trigger from trigger profiles. In various embodiments, a trigger may define trigger conditions. When the trigger conditions associated with a trigger are satisfied, the alert module 2216 may generate an alert. In various embodiments, the alert module 216 monitors and determines if the sensor data, the assessment of the sensor data, and/or the location of the user relative to the medical condition map satisfy trigger conditions such that a trigger is satisfied.

In step 2506, if at least one trigger satisfied, the alert module 2216 may provide an alert. The alert may be provided to emergency services, a physician, or other medical personnel (e.g., a user of medical device 1906). The alert may indicate that a worsening condition, an unexpected outcome or an outcome that is not similar to other patients based on the sensor data of the other patients. In some embodiments, the alert may be based on a quickly changing condition or a condition that is not changing quickly enough based on the sensor data, the assessment of the sensor data, and/or the location of the user relative to the medical condition map.

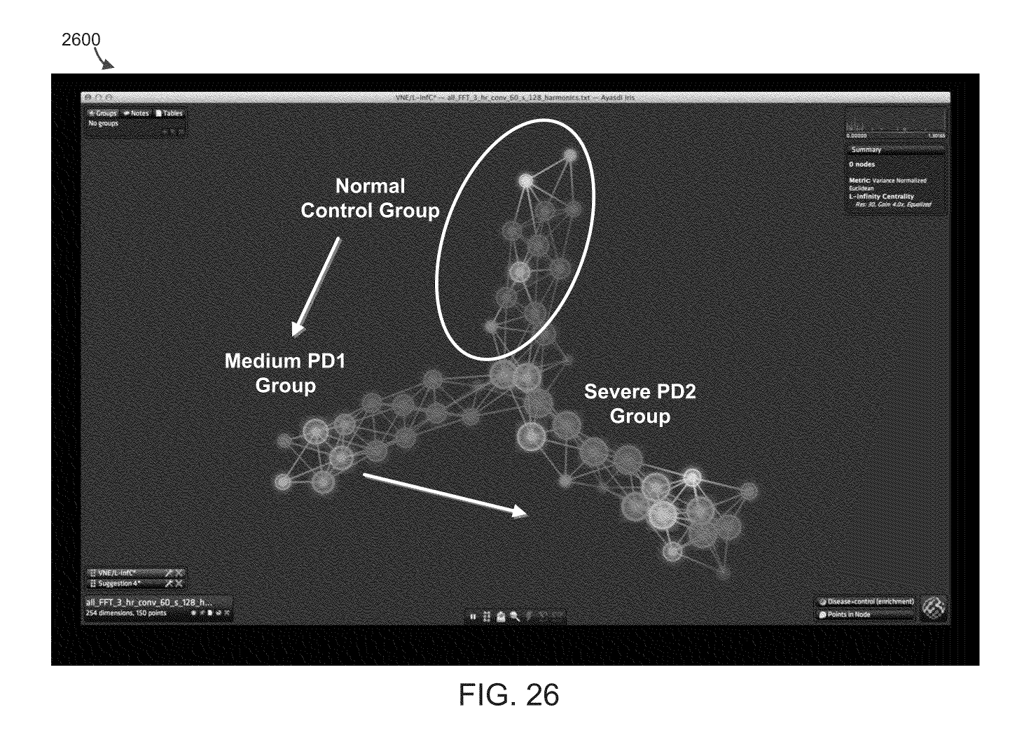

FIG. 26 depicts a visualization of the medical condition map 2600 in some embodiments. The visualization of the medical condition map 2600 may depict accelerometry data for patients with PD. The visualization of the medical condition map 2600 depicts the shape of the data as consisting of three flairs. The first flair includes the control group which may not have PD. The second flair includes a group with medium PD while the third flair includes a group with severe PD.

In some embodiments, differences in the visualization of the medical condition map 2600 may be driven by amplitudes of high order harmonics in accelerometry data. Members of the control group may have attenuated amplitudes at high frequencies compared to the group with medium PD and the group with sever PD (e.g., the data associated with members of the control group may be more data).

Those skilled in the art will appreciate that markers may be utilized to differentiate the severity of disease using accelerometry data. Markers may be used to monitor disease progression or drug efficacy.

The sensor data from which the medical condition map 2600 was generated is based on accelerometry values from a number of mobile devices of different patients. In this example, accelerometry data may include data points sampled anywhere from 1 to 99 times each second. The average values of acceleration, absolute deviation, standard deviation, max deviation; low, low-mid, mid-high and high frequency motion energy for all three axes over each sampled period of 1 s may be provided in the raw data in this example.

A time series of the L-2 norm of the acceleration is generated in this example. The time series may be smoothed (e.g., with Gaussian kernel of 60 s in width). In this example, for each of the subjects 10 overlapping three hour intervals in 1 hr increments may be taken. Those skilled in the art will appreciate that the time series can be generated and/or smoothed using many methods.

From the three-hour intervals time dependence was separated by taking the first 128 complex frequency components in the Fast Fourier Transform. Real and imaginary parts of the logarithm of the harmonics were utilized to build a medical condition map as discussed herein. Those skilled in the art will appreciate that any intervals may be separated out using any number of frequency components. Further, those skilled in the art will appreciate that one or more different transforms may be utilized.

Based on assessment of the accelerometry data, in this example, there appear to be three groups: one that was enriched for the samples from the control patients, and two groups enriched for the PD patients. The differences between the groups may be primarily driven by the amplitudes of high order harmonics: controls had significantly lower intensities relative to the two PD groups, and within the two groups enriched for PD we found a similar situation. The grouping was not sensitive to the phase information.

FIG. 27 depicts a new patient location on a visualization of the medical condition map 2700 before treatment in some embodiments. The new patient may be located on the medical condition map based on the method described with regard to FIG. 24.

The new patient location is identified as the concentric circles. In this example, the patient is identified as being in the group of the severe flair. The patient's location in the visualization of the medical condition map 2700 may be based on sensor data (e.g., accelerometer sensor data) from the new patient's mobile device 1902.

FIG. 28 depicts a new patient location on a visualization of the medical condition map 2800 after treatment in some embodiments. The new patient location is identified as the concentric circles. In this example, the patient is identified as being in the group of the medium flair. As discussed regarding FIG. 27, the patient's location in the visualization of the medical condition map 2800 may be based on sensor data (e.g., accelerometer sensor data) from the new patient's mobile device 1902.

In various embodiments, the visualization of the medical condition map 2700 and/or the visualization of the medical condition map 2800 may be depicted on the medical device 1906 (e.g., at the request of the user of the medical device 1906). In some embodiments, either or both visualizations are not rendered or displayed. For example, the user of the medical device 1906 may receive a text summary and/or graphs summarizing information, displaying the new patient's sensor data, assessments of the new patient's sensor data, and/or alerts.

FIG. 29 depicts a new patient's change in location on a visualization of the medical condition map 2900 after treatment in some embodiments. In various embodiments, various positions of the new patient on the visualization (e.g., as depicted in FIGS. 27 and 28) may be displayed on a visualization of the medical condition map 2900. In this depiction, the positions of the new patient are shown and the positions are annotated with labels indicating when the position was determined, sensor data was received, and/or when sensor data was collected. The arrow may indicate the direction of change.

Although there are only two positions for the new patient, those skilled in the art will appreciate that there may be any number of positions with any number of annotations. Further, there may be any number of arrows indicating direction of change over time.

As discussed herein, the user of the medical device 1906 may control the amount of data being displayed including the number of positions of the new user (e.g., based on time frame, type of sensor data, or the like). In various embodiments, the visualization of the medical condition map 2900 may be automated to depict the different positions of the new patient over time (e.g., based on chronology). Those skilled in the art will appreciate that any or all of the positions may be depicted in any order.

In various embodiments, audio data received from audio sensors (e.g., audio module 2008 of the mobile device) may be utilized to add information for detecting medical attributes (e.g., information related to PD). In some embodiments, the audio data may be filtered or processed based on information from proximity sensors as discussed herein. The following are examples of receiving and processing audio data to assist in identifying and/or creating medical attributes associated to a user of the mobile device 1902.

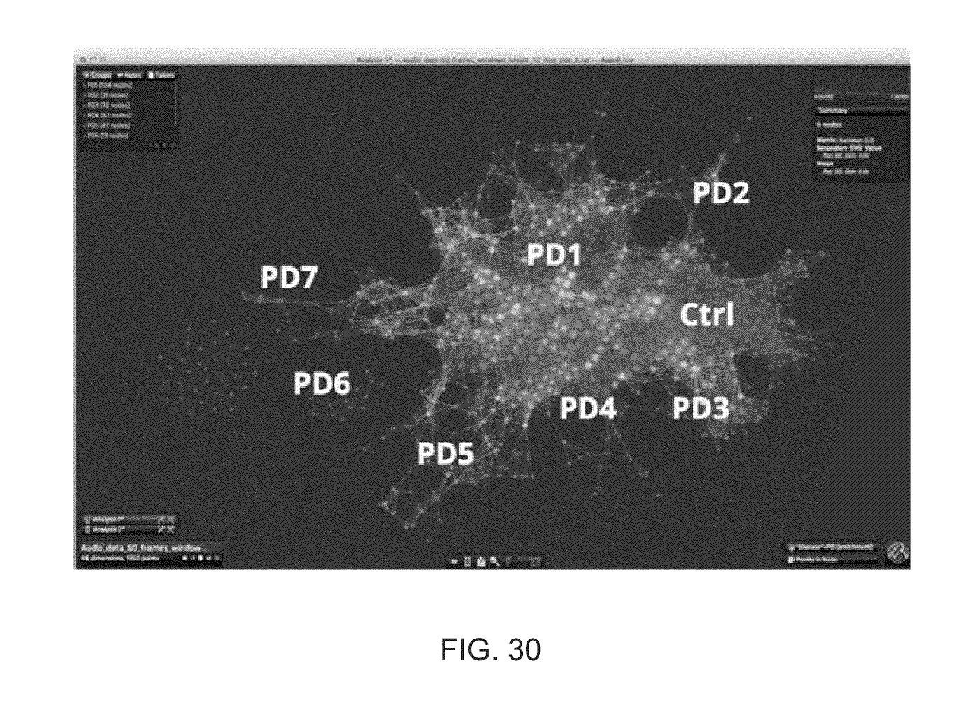

FIG. 30 is a display of a map depicting audio data at 60 second window of length 12 second intervals with 4 second hops (e.g., 12 second intervals that being every multiple of four seconds from the beginning of the time sequences). In an example, audio data consists of 12 Mel-frequency cepstral coefficients (MFCC) for every second. Since a mobile device 1902, such as a smartphone, may constantly measure audio, most of the data may be ambience noise. To be able to analyze speech, the audio module 2008 or the patient data assessment module 2210 may integrate audio data with proximity sensor data from a proximity sensor of the mobile device 1902. In one example, the audio module 2008 or the patient data assessment module 2210 may select time intervals where a proximity sensor of the mobile device 1902 indicated that the phone may have been close to the body or face of the subject uninterrupted for periods between 2 and 10 minutes. The audio module 2008 or the patient data assessment module 2210 may collect one minute audio data from such intervals starting at 30 seconds. In some embodiments, up to 10 described 60 second intervals may be selected, or the maximum number of such intervals, whichever number was smaller. In one example, for Takens embedding, 12 second intervals with 4 second hops may be utilized.

In this example, a network is generated based in MFCC.3, MFCC.6, MFCC.9 and MFCC.12 using a Euclidean (e.g., L2) distance metric and two lenses: projection into secondary SVD vector and mean. Seven (7) different groups of PD patients and one large control group are identified. The network and the groups are depicted on FIG. 30. For each group an average values may be evaluated for Mel-spaced filterbanks 3, 6, 9 and 12.

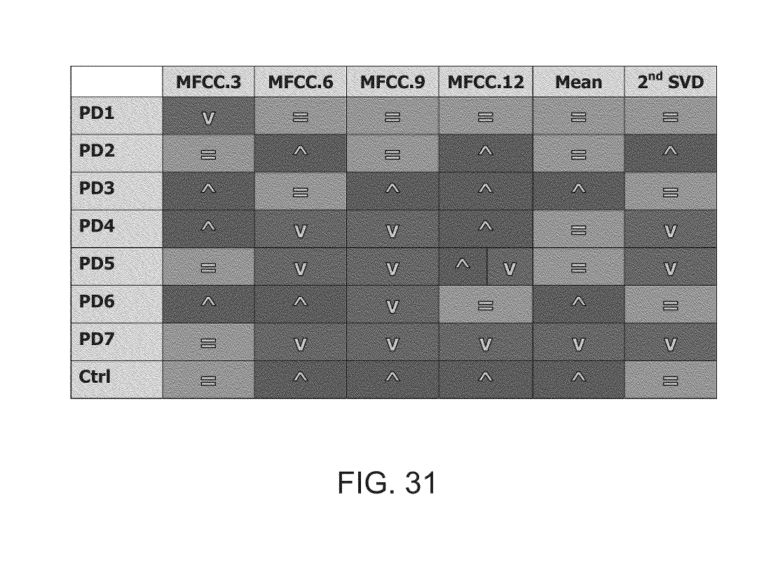

FIG. 31 depicts a table that describes the groups in some embodiments. For each of the 7 PD groups and for the control group, the table in FIG. 31 is depicted with values representing average values of Mel-frequency cepstral coefficients and lenses (mean and 2^{nd} SVD Value) relative to the average on the network. “V” indicates values lower than the average, “=” on a background indicate about average and “̂” on a background indicate values higher than average.

Those skilled in the art will appreciate that it is possible to use audio data to separate PD patients from normal controls, however this data may not be as clean as acceleration data as there may be no information on when subjects may be talking on the phone. Rather than working with MFCC which indicates power per frequency band, raw sound data may be utilized in some embodiments. MFCCs may be calculated over intervals of 1 s, where speech recognition time intervals may be 40× shorter, under the assumption that during such short intervals sound is stationary. This assumption may or may not be valid for PD patients.

Those skilled in the art will appreciate that any sound compression technique may be utilized before providing these methods.

In some embodiments, acceleration is analyzed in three hour intervals, convolved with a Gaussian of σ=60 s. In one example, there are 3×3,600=10,800 measurements in each 3 hr interval. To expedite FFT calculations in this example, 10,800 is increased to the first power of 2, which is 2¹⁴=16,384. Fourier transform gives the same number of complex Fourier coefficients, from which the top 128 is selected. Justification for such approach is low pass filtering with a Gaussian kernel.

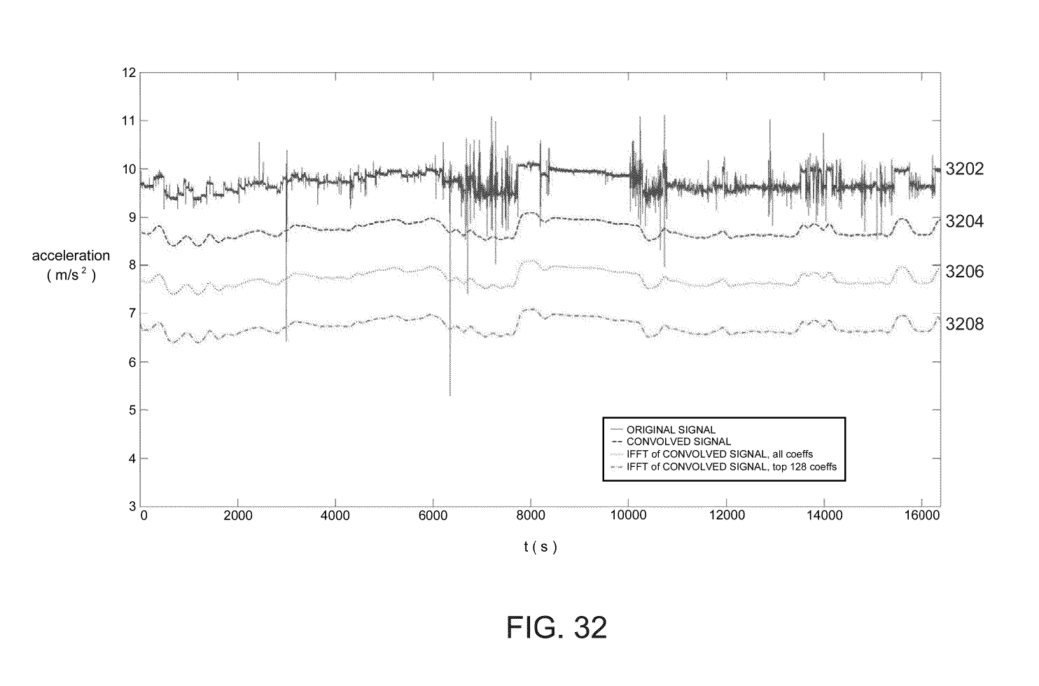

FIG. 32 depicts a comparison between the original acceleration time series data 3202 over a 3 hr interval for an exemplary subject in some embodiments. The smoothed version of that curve is presented by dashed line 3204 offset by −1 m/s2. Inverse FT calculation using all Fourier coefficients is shown in the 3206 line (for clarity offset by −2 m/s²) and inverse FT calculation for top 128 Fourier coefficients is plotted in the 3208 line (offset by −3 m/s² for clarity). Correlation between the convolved signal 3204 and inverse FT signal where top 128 harmonics were retained 3208 may be 0.99 and above in the absence of Gibbs phenomenon.

Correlations between the convolved signal and the complete IFFT signal in FIG. 32 is very high, typically 1. Correlation for IFFT of the subset with top 128 harmonics is usually smaller by 0.01 or 0.001. In extreme cases of abrupt discontinuities in acceleration time series (i.e. Gibbs paradox in classical Fourier analysis), the correlation may drop to 0.9. Correlation may, in some embodiments, be significantly improved by using a Hamming window on the data.

With the procedure of retaining the top 128 complex Fourier coefficients, 2¹⁴ time values may be replaced with 2⁷ complex frequency values, which are essentially 2⁸ real values. Therefore, the dataset size is effectively reduced by a factor of 64. For TDA, in some embodiments, only real parts of the complex amplitudes may be responsible for generating the network shape. Therefore, in this example, the total data size reduction to find insight in the acceleration data is a factor of 128.

Audio information received and/or processed may be utilized to locate a user relative to a medical condition map as discussed herein. Those skilled in the art will appreciate that although accelerometry data is discussed in many examples, audio information and/or other sensor data may be utilized in systems and methods described herein.

The above-described functions and components can be comprised of instructions that are stored on a storage medium (e.g., a computer readable storage medium). The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A system comprising:
a map including a plurality of groupings and interconnections of the groupings, each grouping having one or more patient members that share biological similarities, each interconnection interconnecting groupings that share at least one common patient member, the map identifying a set of groupings and a set of interconnections having a medical characteristic of a set of medical characteristics; and
a patient data assessment module configured to receive sensor data from a user's mobile device and to assess the sensor data to generate user medical attributes, to determine whether the user shares the biological similarities with the one or more patient members of each grouping based, at least in part, on the user medical attributes, thereby enabling association of the user with one or more of the set of medical characteristics.

2. The system of claim 1 wherein the biological similarities represent similarities of measurements of sensor data of mobile devices associated with the one or more patient members.

3. The system of claim 2 wherein the sensor data comprises accelerometer sensor data.

4. The system of claim 1 wherein the map is generated by an analysis system configured to receive sensor data associated with the one or more patient members, apply a filtering function to generate a reference space, generate a cover of the reference space based on a resolution, the cover including cover data associated with the filtered sensor data, and cluster the cover data based on a metric.

5. The system of claim 4, wherein the filtering function is a density estimation function.

6. The system of claim 4 wherein the metric is a Pearson correlation.

7. The system of claim 1 wherein the patient data assessment module configured to determine whether the user shares the biological similarities with the one or more patient members of each grouping comprises the patient data assessment module configured to determine a distance between biological data of a subset of patient members and sensor data of the user, compare distances between a representative patient member of the subset of patient members and the distances determined for the user, and determine a location of the user relative to at least one of the patient members.

8. The system of claim 1 wherein the map is not displayed.

9. The system of claim 1, further comprising a trigger module configured to retrieve a trigger profile based on a condition classification, to determine if the user medical attributes satisfies trigger conditions of a trigger associated with the trigger profile, and to provide an alert based on the determination.

10. The system of claim 1 wherein the medical characteristic comprises a clinical outcome.

11. A method comprising:
receiving sensor data from a user's mobile device;
assessing the sensor data to generate user medical attributes of a user;
determining distances between biological data of patient members of map and medical attributes from the user, the map including a plurality of groupings and interconnections of the groupings, each grouping having one or more of the patient members that share biological similarities, each interconnection interconnecting groupings that share at least one common patient member, the map identifying a set of groupings and a set of interconnections having a medical characteristic of a set of medical characteristics;
comparing distances between the one or more patient members and the distances determined for the user; and
determining a location of the user relative to the member patients of the map based on the comparison, thereby enabling association of the new patient with one or more of the set of medical characteristics.

12. The method of claim 11 wherein the biological similarities represent similarities of sensor data of mobile devices associated with the one or more patient members.

13. The method of claim 11 wherein the sensor data comprises accelerometer sensor data.

14. The method of claim 11, further comprising:
receiving sensor data associated with the one or more patient members,
applying a filtering function to generate a reference space, generate a cover of the reference space based on a resolution, the cover including cover data associated with the filtered sensor data, and
clustering the cover data based on a metric.

15. The method of claim 14 wherein the filtering function is a density estimation function.

16. The method of claim 14 wherein the metric is a Pearson correlation.

17. The method of claim 14, further comprising comparing distances to one or more of the patient members closest to the user's filtered sensor data with a diameter of at least one grouping and indicating that the user is associated with the grouping based on the comparison.

18. The system of claim 1, further comprising retrieving a trigger profile based on a condition classification, determining if the user medical attributes satisfies trigger conditions of a trigger associated with the trigger profile, and providing an alert based on the determination.

19. The method of claim 11 wherein the medical characteristic comprises a clinical outcome.

20. A non-transitory computer readable medium comprising instructions, the instructions being executable by a processor to perform a method, the method comprising:
receiving sensor data from a user's mobile device;
assessing the sensor data to generate user medical attributes of a user;
determining distances between biological data of patient members of map and medical attributes from the user, the map including a plurality of groupings and interconnections of the groupings, each grouping having one or more of the patient members that share biological similarities, each interconnection interconnecting groupings that share at least one common patient member, the map identifying a set of groupings and a set of interconnections having a medical characteristic of a set of medical characteristics;
comparing distances between the one or more patient members and the distances determined for the user; and
determining a location of the user relative to the member patients of the map based on the comparison, thereby enabling association of the new patient with one or more of the set of medical characteristics.
